(19) United States
(12) Patent Application Publication
(10) Pub. No.: US 2016/0129641 A1
(43) Pub. Date: May 12, 2016

(54) THREE-DIMENSIONAL OBJECT FORMATION APPARATUS, THREE-DIMENSIONAL OBJECT FORMATION SYSTEM, CONTROL METHOD OF THREE-DIMENSIONAL OBJECT FORMATION APPARATUS, AND CONTROL PROGRAM OF THREE-DIMENSIONAL OBJECT FORMATION APPARATUS

(71) Applicant: SEIKO EPSON CORPORATION, Tokyo (JP)

(72) Inventor: Satoshi YAMAZAKI, Nagano (JP)

(21) Appl. No.: 14/855,558

(22) Filed: Sep. 16, 2015

(30) Foreign Application Priority Data
Nov. 12, 2014 (JP) 2014-230165

(51) Int. Cl. B29C 67/00; G05B 19/4099

(52) U.S. Cl. CPC B29C 67/0088; G05B 19/4099; G05B 2219/35134; G05B 2219/49007; B33Y 50/02

(57) ABSTRACT

Provided is a three-dimensional object formation apparatus including: a head unit which discharges a plurality of types of liquid including first liquid including chromatic color material components and second liquid having a smaller number of color material components than that of the first liquid and forms dots with the discharged liquid; a curing unit which cures the dots; and a formation control unit which controls the head unit so that a three-dimensional object is formed with the cured dots, in which the formation control unit controls the head unit so that the three-dimensional object which includes a first layer liquid and a second layer and in which the second layer includes an outer surface of the three-dimensional object and is provided so as to separate the first layer and the outer surface of the three-dimensional object, is formed.

This application claims priority to Japanese Patent Application No. 2014-230165 filed on Nov. 12, 2014. The entire disclosure of Japanese Patent Application No. 2014-230165 is hereby incorporated herein by reference.

### BACKGROUND

1. Technical Field

The present invention relates to a three-dimensional object formation apparatus, a three-dimensional object formation system, a control method of a three-dimensional object formation apparatus, and a control program of a three-dimensional object formation apparatus.

2. Related Art

In recent years, various three-dimensional object formation apparatuses such as a 3D printer have been proposed. The three-dimensional object formation apparatus cures dots which are formed by discharging liquid such as ink, forms a formation body having a predetermined thickness with the cured dots, and laminates the formed formation bodies to form a three-dimensional object. In such a three-dimensional object formation apparatus, in order to form a colored three-dimensional object, various techniques of forming a surface portion including an outer surface of the three-dimensional object with chromatic liquid such as color ink have been proposed (for example, see JP-A-2013-075390).

However, the number of color material components included in the chromatic liquid such as color ink is larger than transparent liquid such as clear ink, for example. Accordingly, the strength of the portion formed with the chromatic liquid may be decreased, compared to a portion formed with liquid having a small number of color material components such as transparent liquid. Thus, when forming the surface portion of the three-dimensional object with the chromatic liquid, the surface portion of the three-dimensional object formed with the chromatic liquid may be peeled off over time due to deterioration. In this case, image quality of an image such as a shape or a character represented with the chromatic liquid may be deteriorated.

### SUMMARY

An advantage of some aspects of the invention is to provide a technology of decreasing a degree of deterioration over time regarding image quality of an image represented as a color applied to a three-dimensional object which is formed by a three-dimensional object formation apparatus.

According to an aspect of the invention, there is provided a three-dimensional object formation apparatus including: a head unit which discharges a plurality of types of liquid including a first liquid including chromatic color material components and a second liquid having a smaller number of color material components than that of the first liquid and forms dots with the discharged liquid; a curing unit which cures the dots; and a formation control unit which controls the head unit so that a three-dimensional object is formed with the cured dots, in which the formation control unit controls the head unit so that the three-dimensional object which includes a first layer formed of a plurality of dots including the dots formed with the first liquid and a second layer formed of a plurality of dots formed with the second liquid and in which the second layer includes an outer surface of the three-dimensional object and is provided so as to separate the first layer and the outer surface of the three-dimensional object, is formed.

That is, the three-dimensional object formation apparatus according to the aspect of the invention may include a head unit which discharges a plurality of types of liquid including a first liquid including chromatic color material components and a second liquid having a smaller number of color material components than that of the first liquid and forms dots with the discharged liquid, and a curing unit which cures the dots, the three-dimensional object formation apparatus forms a three-dimensional object by sequentially laminating formation bodies formed with the cured dots, the three-dimensional object includes a first layer formed of a plurality of dots including the dots formed with the first liquid and a second layer formed of a plurality of dots formed with the second liquid, and the second layer includes an outer surface of the three-dimensional object and is provided so as to separate the first layer and the outer surface of the three-dimensional object.

In this case, by providing the second layer so as to separate the first layer and the outer surface of the three-dimensional object, it is possible to protect the first layer with the second layer. Accordingly, it is possible to prevent the peeling-off of a part of or the entire first layer from the three-dimensional object. That is, it is possible to decrease a degree of deterioration over time regarding image quality of the shape, the color, and other images of the three-dimensional object represented with the chromatic color material components included in the first layer.

Since the number of the color material components of the second liquid for forming the second layer is smaller than that of the first liquid, it is easy to ensure the strength when the liquid is cured. Therefore, it is possible to increase the strength of the surface portion of the three-dimensional object including the outer surface of the three-dimensional object, compared to a case of not including the second layer in the three-dimensional object.

Clear ink, for example, can be used as the second liquid.

In the three-dimensional object formation apparatus described above, it is preferable that the formation control unit controls the head unit so that the three-dimensional object in which the first layer shows the color shown by model data and is provided to be separated from the outer surface of the three-dimensional object which is determined based on the shape shown by the model data by a distance corresponding to a thickness of the second layer, is formed based on the model data for designating the shape and the color of the three-dimensional object.

In this case, it is possible to form the three-dimensional object so that the shape of the three-dimensional object is the shape shown by the model data.

In the three-dimensional object formation apparatus described above, it is preferable that the three-dimensional object is formed by sequentially overlapping a plurality of formation bodies, a formation body which is initially formed and a formation body which is finally formed are formed with the second liquid, the formation bodies are formed with the cured dots, and the formation control unit controls the head unit so that the formation bodies are formed based on the model data.

In this case, a portion of the three-dimensional object which easily comes in contact with another object, such as a bottom portion of the three-dimensional object, is formed with the second liquid which easily ensures the strength. Therefore, it is possible to decrease a degree of deterioration over time regarding the three-dimensional object.

In the three-dimensional object formation apparatus described above, it is preferable that the head unit discharges a third liquid which reflects visible light at a rate equal to or greater than a predetermined rate, and the formation control unit controls the head unit so that a three-dimensional object which is a three-dimensional object including a third layer formed of a plurality of dots formed with the third liquid and in which the first layer is provided so as to separate the first layer, and the third layer and the second layer, is formed.

In this case, most of light emitted to the three-dimensional object from the outside of the three-dimensional object is reflected by the first layer or the third layer. Accordingly, it is possible to prevent transmission of light emitted to the three-dimensional object from the outside of the three-dimensional object, to the inner side with respect to the third layer. Therefore, it is possible to prevent the color of the inside of the three-dimensional object from being visualized from the outside of the three-dimensional object. Thus, it is possible to prevent the three-dimensional object from being visualized as a color different from the color as originally intended.

In the three-dimensional object formation apparatus described above, it is preferable that the formation control unit controls the head unit so that the three-dimensional object which is provided so as to have a constant thickness of the second layer is formed.

In this case, when the image such as the pattern or the character is represented with the color applied to the first layer, it is possible to prevent distortion of the shape of the image due to the second layer.

According to another aspect of the invention, there is provided a three-dimensional object formation system which forms a three-dimensional object based on model data for designating a shape and a color of the three-dimensional object to be formed, the system including: a head unit which discharges a plurality of types of liquid including a first liquid including chromatic color material components and a second liquid having a smaller number of color material components than that of the first liquid and forms dots with the discharged liquid; a curing unit which cures the dots; and a system control unit which controls the head unit so that the three-dimensional object is formed with the cured dots based on the model data, in which the system control unit controls the head unit so that the three-dimensional object which includes a first layer which is formed of a plurality of dots including the dots formed with the first liquid and for representing the color shown by the model data, and a second layer formed of a plurality of dots formed with the second liquid, includes an outer surface of the three-dimensional object determined based on the shape shown by the model data, and is provided so as to separate the first layer and the outer surface of the three-dimensional object, and in which the first layer is provided so as to be separated from the outer surface of the three-dimensional object by a distance corresponding to a thickness of the second layer, is formed.

In this case, by providing the second layer so as to separate the first layer and the outer surface of the three-dimensional object, it is possible to protect the first layer with the second layer. Accordingly, it is possible to prevent the peeling-off of a part of or the entire first layer from the three-dimensional object. That is, it is possible to decrease a degree of deterioration over time regarding image quality of the shape, the color, and other images of the three-dimensional object represented with the chromatic color material components included in the first layer.

According to still another aspect of the invention, there is provided a control method of a three-dimensional object formation apparatus which includes a head unit which discharges a plurality of types of liquid including a first liquid including chromatic color material components and a second liquid having a smaller number of color material components than that of the first liquid and forms dots with the discharged liquid, and a curing unit which cures the dots, the method including: controlling the head unit so that the three-dimensional object which includes a first layer formed of a plurality of dots including the dots formed with the first liquid and a second layer formed of a plurality of dots formed with the second liquid and in which the second layer includes an outer surface of the three-dimensional object and is provided so as to separate the first layer and the outer surface of the three-dimensional object, is formed.

In this case, by providing the second layer so as to separate the first layer and the outer surface of the three-dimensional object, it is possible to protect the first layer with the second layer. Accordingly, it is possible to prevent the peeling-off of a part of or the entire first layer from the three-dimensional object. That is, it is possible to decrease a degree of deterioration over time regarding image quality of the shape, the color, and other images of the three-dimensional object represented with the chromatic color material components included in the first layer.

According to still another aspect of the invention, there is provided a control program of a three-dimensional object formation apparatus which includes a head unit which discharges a plurality of types of liquid including a first liquid including chromatic color material components and a second liquid having a smaller number of color material components than that of the first liquid and forms dots with the discharged liquid, a curing unit which cures the dots, and a computer, the program causing the computer to function as: a formation control unit which controls the head unit so that the three-dimensional object which includes a first layer formed of a plurality of dots including the dots formed with the first liquid and a second layer formed of a plurality of dots formed with the second liquid and in which the second layer includes an outer surface of the three-dimensional object and is provided so as to separate the first layer and the outer surface of the three-dimensional object, is formed with the cured dots.

In this case, by providing the second layer so as to separate the first layer and the outer surface of the three-dimensional object, it is possible to protect the first layer with the second layer. Accordingly, it is possible to prevent the peeling-off of a part of or the entire first layer from the three-dimensional object. That is, it is possible to decrease a degree of deterioration over time regarding image quality of the shape, the color, and other images of the three-dimensional object represented with the chromatic color material components included in the first layer.

### BRIEF DESCRIPTION OF THE DRAWINGS

The invention will be described with reference to the accompanying drawings, wherein like numbers reference like elements.

FIG. 1 is a block diagram showing a configuration of a three-dimensional object formation system according to the invention.

FIGS. 2A to 2E are explanatory diagrams for illustrating the formation of an object by the three-dimensional object formation system.

FIG. 3 is a schematic sectional view of a three-dimensional object formation apparatus.

FIG. 4 is a schematic sectional view of a recording head.

FIGS. 5A to 5C are explanatory diagrams for illustrating an operation of a discharging unit when supplying a driving signal.

FIG. 6 is a plan view showing an arrangement example of nozzles of the recording head.

FIG. 7 is a block diagram showing a configuration of a driving signal generation unit.

FIG. 8 is an explanatory diagram showing the content of a selection signal.

FIG. 9 is a timing chart showing waveforms of a driving waveform signal.

FIG. 10 is a flowchart showing a data generation process and a formation process.

FIGS. 11A to 11D are explanatory diagrams for illustrating a three-dimensional object.

FIG. 12 is a flowchart showing a shape complementation process.

FIGS. 13A to 13F are explanatory diagrams for illustrating a three-dimensional object according to comparative examples.

FIGS. 14A to 14C are explanatory diagrams for illustrating a case where a three-dimensional object is a component.

FIGS. 15A to 15C are explanatory diagrams for illustrating a three-dimensional object as a component.

FIG. 16 is a flowchart showing a data generation process and a formation process according to Modification Example 3.

FIGS. 17A to 17F are explanatory diagrams for illustrating the formation of a three-dimensional object by the three-dimensional object formation system according to Modification Example 3.

### DESCRIPTION OF EXEMPLARY EMBODIMENTS

Hereinafter, embodiments for realizing the invention will be described with reference to the drawings. Herein, in each drawing, dimensions and scales of each drawing are appropriately modified from the actual dimensions and scales. The embodiments which will be described below are preferable specific examples of the invention, and therefore, various technologically preferable limitations are set. However, the scope of the invention is not limited to the embodiments, unless there is a limitation of the invention in the following description.

### A. EMBODIMENT

In the embodiment, as a three-dimensional object formation apparatus, an ink jet type three-dimensional object formation apparatus which discharges a curable ink (an example of “liquid”) such as resin ink containing a resin emulsion or ultraviolet curable ink to form a three-dimensional object Obj will be described as an example.

### 1. Configuration of Three-Dimensional Object Formation System

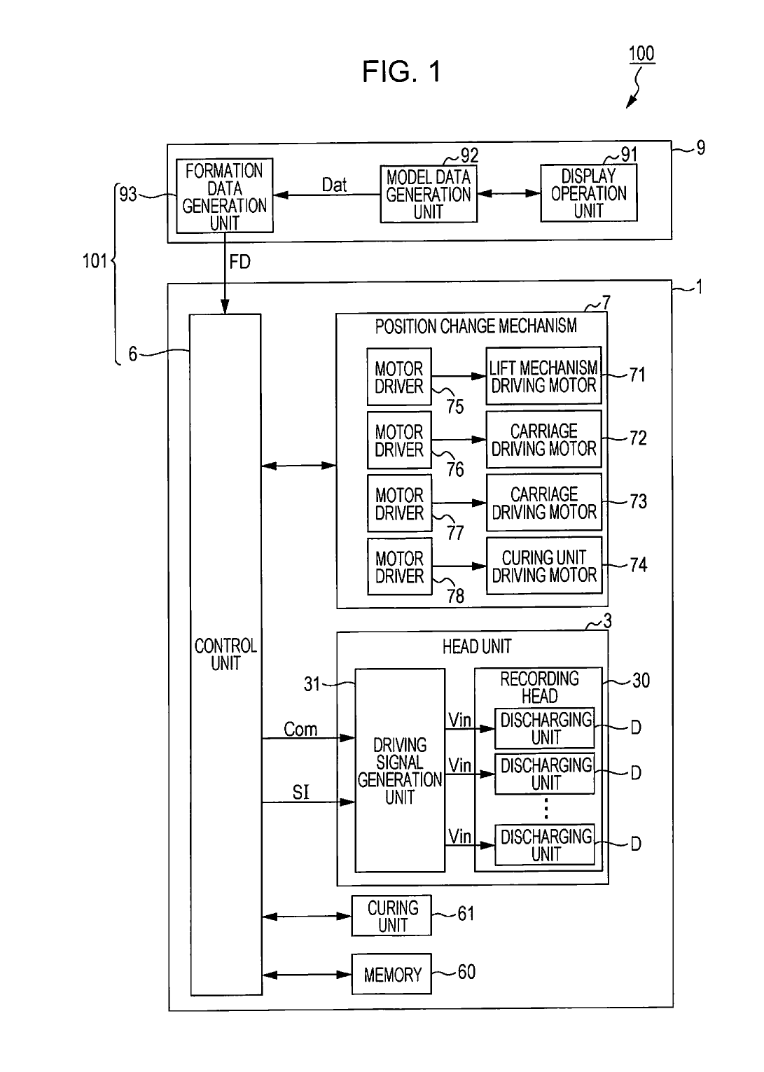

Hereinafter, a configuration of a three-dimensional object formation system 100 including a three-dimensional object formation apparatus 1 according to the embodiment will be described with reference to FIG. 1 to FIG. 9.

FIG. 1 is a functional block diagram showing a configuration of the three-dimensional object formation system 100.

As shown in FIG. 1, the three-dimensional object formation system 100 includes the three-dimensional object formation apparatus 1 which executes a formation process of discharging ink, forming a layered formation body LY having a predetermined thickness ΔZ with dots formed by the discharged ink, and laminating the formation bodies LY to form a three-dimensional object Obj, and a host computer 9 which executes a data generation process of generating formation body data FD which determines a shape and a color of each formation body LY configuring the three-dimensional object Obj which is formed by the three-dimensional object formation apparatus 1.

### 1.1. Host Computer

As shown in FIG. 1, the host computer 9 includes a CPU (not shown) which controls an operation of each unit of the host computer 9, a display unit (not shown) such as a display, an operation unit 91 such as a keyboard or a mouse, an information memory (not shown) on which a control program of the host computer 9, a driver program of the three-dimensional object formation apparatus 1, and an application program such as computer aided design (CAD) software are recorded, a model data generation unit 92 which generates model data Dat, and a formation data generation unit 93 which executes a data generation process of generating the formation body data FD based on the model data Dat.

Herein, the model data Dat is data showing the shape and the color of the model representing a three-dimensional object Obj which is to be formed by the three-dimensional object formation apparatus 1 and is data for designating the shape and the color of the three-dimensional object Obj. Hereinafter, the color of the three-dimensional object Obj includes a method of applying the plurality of colors when the plurality of colors are applied to the three-dimensional object Obj, that is, the pattern, characters, and other images represented by the plurality of colors applied to the three-dimensional object Obj.

The model data generation unit 92 is a functional block which is realized by execution of the application program recorded on the information memory by the CPU of the host computer 9. The model data generation unit 92 is, for example, a CAD application, and generates the model data Dat which designates the shape and the color of the three-dimensional object Obj based on information which is input by operating the operation unit 91 by a user of the three-dimensional object formation system 100.

In the embodiment, a case where the model data Dat designates an external shape of the three-dimensional object Obj is assumed. That is, a case where the model data Dat is data which designates a shape of a hollow object in a case where it is assumed that the three-dimensional object Obj is the hollow object, that is, a shape of an outline of the three-dimensional object Obj, is assumed. For example, when the three-dimensional object Obj is a sphere, the model data Dat shows a spherical shape which is an outline of the sphere.

However, the invention is not limited to such an embodiment, and the model data Dat may include at least information in which the shape of the outer shape of the three-dimensional object Obj can be specified. For example, the model data Dat may designate a shape or a material of the inside of the three-dimensional object Obj, in addition to the outer shape or the color of the three-dimensional object Obj.

As the model data Dat, a data format such as Additive Manufacturing File Format (AMF) or Standard Triangulated Language (STL) can be used, for example.

The formation data generation unit 93 is a functional block which is realized by execution of the driver program of the three-dimensional object formation apparatus 1 recorded on the information memory by the CPU of the host computer 9. The formation data generation unit 93 executes a data generation process of generating the formation body data FD which determines a shape and a color of the formation body LY formed by the three-dimensional object formation apparatus 1, based on the model data Dat generated by the model data generation unit 92.

Hereinafter, a case where the three-dimensional object Obj is formed by laminating Q layered formation bodies LY is assumed (Q is a natural number satisfying an expression of Q≧2). Hereinafter, the process of forming the formation bodies LY by the three-dimensional object formation apparatus 1 is referred to as a lamination process. That is, the formation process of forming the three-dimensional object Obj by the three-dimensional object formation apparatus 1 includes Q times of the lamination processes.

Hereinafter, a formation body LY which is formed in the q-th lamination process among the Q times of the lamination processes included in the formation process is referred to as a formation body LY[q] and the formation body data FD which determines the shape and the color of the formation body LY[q] is referred to as the formation body data FD[q] (q is a natural number satisfying an expression of 1≦q≦Q).

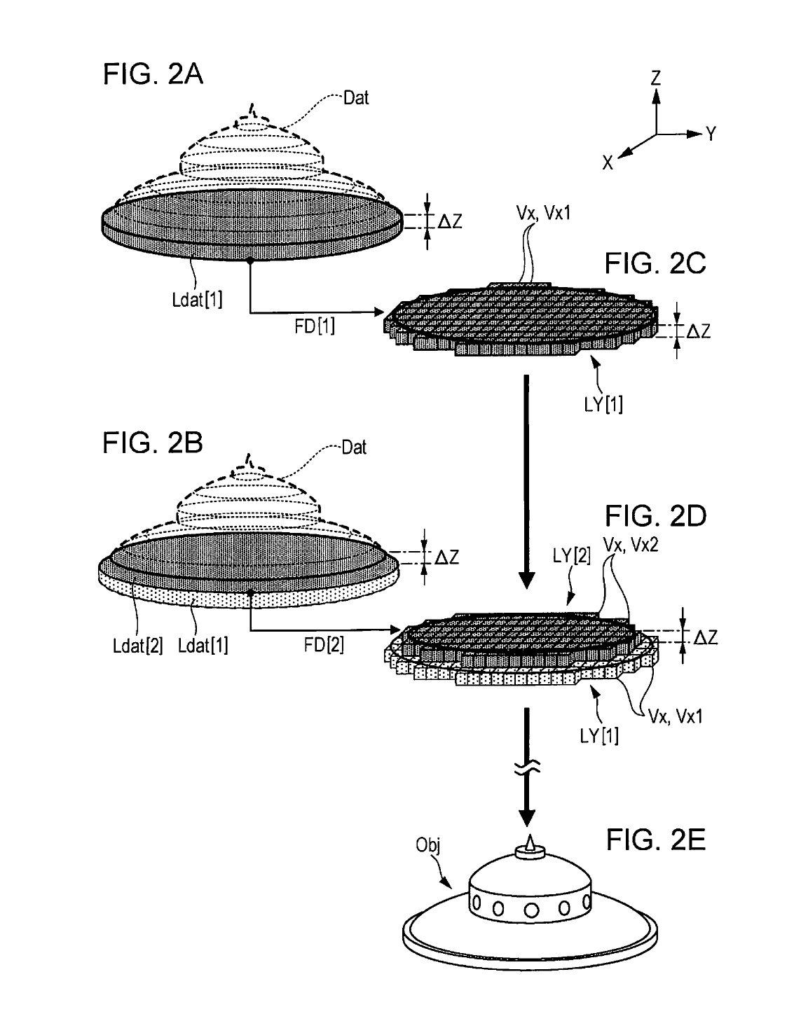

FIGS. 2A to 2E are explanatory diagrams for illustrating a relationship between the model data Dat and the formation body LY formed based on the formation body data FD.

As shown in FIGS. 2A and 2B, in order to generate formation body data items FD[1] to FD[Q] which determine the shape and the color of formation bodies LY[1] to LY[Q] having a predetermined thickness ΔZ, the formation data generation unit 93 first slices a three-dimensional shape shown by the model data Dat into the predetermined thickness ΔZ to generate section model data items Ldat[1] to Ldat[Q] corresponding to the formation bodies LY[1] to LY[Q]. Herein, the section model data Ldat is data showing the shape and the color of the section body which is obtained by slicing the shape of the three-dimensional shape shown by the model data Dat. However, the section model data Ldat may be data including the shape and the color of the section when the three-dimensional shape shown by the model data Dat is sliced. FIG. 2A shows the section model data Ldat[1] corresponding to the formation body LY[1] which is formed in the first lamination process and FIG. 2B shows the section model data Ldat[2] corresponding to the formation body LY[2] which is formed in the second lamination process.

Next, in order to form the formation body LY[q] corresponding to the shape and the color shown by the section model data Ldat[q], the formation data generation unit 93 determines the arrangement of dots to be formed by the three-dimensional object formation apparatus 1 and outputs the determined results as the formation body data FD[q]. That is, the formation body data FD[q] is data which designates dots to be formed in each of plural voxels Vx, when the shape and the color shown by the section model data Ldat[q] are segmented in a granular shape and the shape and the color shown by the section model data Ldat[q] are represented as an assembly of voxels Vx. Herein, the voxel Vx is a cuboid or a cube having a predetermined size and is a cuboid or a cube having the predetermined thickness ΔZ and a predetermined volume. In the embodiment, the volume and the size of the voxel Vx are determined according to the size of the dots which can be formed by the three-dimensional object formation apparatus 1. Hereinafter, the voxel Vx corresponding to the formation body LY[q] may be referred to as a voxel Vxq.

Hereinafter, a constituent element of the formation body LY configuring the three-dimensional object Obj which is formed corresponding to one voxel Vx and has the predetermined volume and the predetermined thickness ΔZ may be referred to as a unit structure. The details will be described later, and the unit structure is configured with one or the plurality of dots. That is, the unit structure is one or the plurality of dots which are formed so as to satisfy one voxel Vx. That is, in the embodiment, the formation body data FD designates that one or the plurality of dots are formed in each voxel Vx.

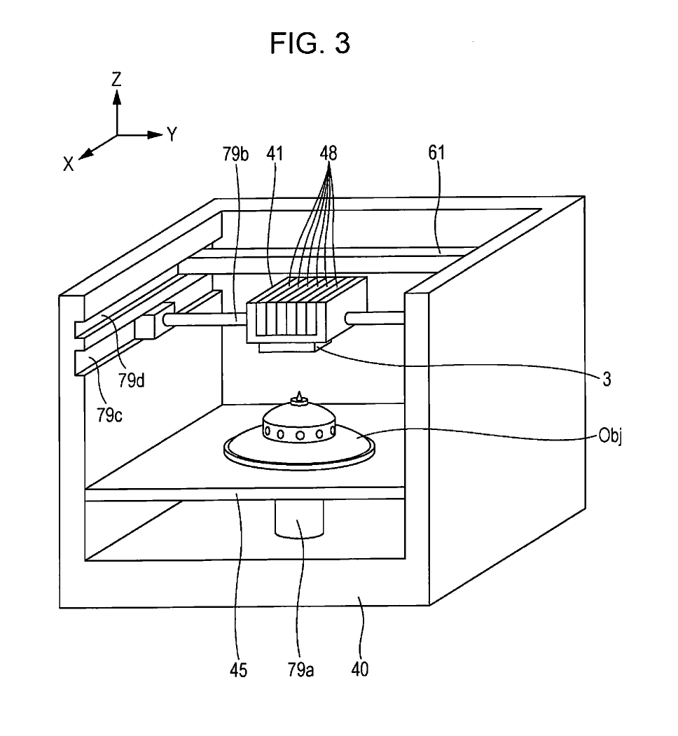

As shown in FIGS. 2C and 2D, the three-dimensional object formation apparatus 1 executes the lamination process of forming the formation body LY[q] based on the formation body data FD[q] generated by the formation data generation unit 93. FIG. 2C shows the first formation body LY[1] formed on a formation table 45 (see FIG. 3) based on the formation body data FD[1] generated from the section model data Ldat[1] and FIG. 2D shows the second formation body LY[2] formed on the formation body LY[1] based on the formation body data FD[2] generated from the section model data Ldat[2].

As shown in FIG. 2E, the three-dimensional object formation apparatus 1 forms the three-dimensional object Obj by sequentially laminating the formation bodies LY[1] to LY[Q] formed based on the formation body data items FD[1] to FD[Q].

As described above, the model data Dat according to the embodiment designates the shape of the outer shape (shape of the outline) of the three-dimensional object Obj. Accordingly, when the three-dimensional object Obj having the shape shown by the model data Dat is reliably formed, the shape of the three-dimensional object Obj becomes a hollow shape only having an outline without any thickness. However, when forming the three-dimensional object Obj, it is preferable to determine the shape of the inside of the three-dimensional object Obj, by considering the strength of the three-dimensional object Obj. Specifically, when forming the three-dimensional object Obj, it is preferable that a part or the entirety of the inside of the three-dimensional object Obj has a solid structure.

Accordingly, as shown in FIGS. 2A to 2E, the formation data generation unit 93 according to the embodiment generates the formation body data FD so that a part or the entirety of the inside of the three-dimensional object Obj has a solid structure, regardless of the fact that the shape designated by the model data Dat is a hollow shape.

Hereinafter, a process of complementing the hollow portion having a shape shown by the model data Dat and generating the section model data Ldat showing the shape in which a part of or the entire hollow portion has a solid structure is referred to as a shape complementation process. The shape complementation process and the structure of the inside of the three-dimensional object Obj designated by the data generated by the shape complementation process will be described later in detail.

In the example shown in FIGS. 2A to 2E, a voxel Vx1 configuring the formation body LY[1] formed in the first lamination process exists on the lower side (negative Z direction) of a voxel Vx2 configuring the formation body LY[2] formed in the second lamination process. However, the voxel Vx1 may not exist on the lower side of the voxel Vx2 depending on the shape of the three-dimensional object Obj. In such a case, although a dot is attempted to be formed in the voxel Vx2, the dot may fall down. Accordingly, when an expression of “q≧2” is satisfied, it is necessary to provide a support for supporting the dots formed in the voxel Vxq on the lower side of the voxel Vxq, in order to form the dots configuring the formation body LY[q] in the voxel Vxq as originally intended.

Therefore, in the embodiment, the formation body data FD includes the data which determines the shape of the support which is necessary when forming the three-dimensional object Obj, in addition to the three-dimensional object Obj. That is, in the embodiment, both of a portion of the three-dimensional object Obj to be formed in the q-th lamination process and a portion of the support to be formed in the q-th lamination process are included in the formation body LY[q]. That is, the formation body data FD[q] includes data representing the shape and the color of the part of the three-dimensional object Obj formed as the formation body LY[q] as an assembly of the voxel Vxq, and data representing the shape of the portion of the support formed as the formation body LY[q] an assembly of the voxel Vxq.

The formation data generation unit 93 according to the embodiment determines whether or not it is necessary to provide the support for forming the voxel Vxq, based on the section model data Ldat and the model data Dat. When the result of the determination is positive, the formation data generation unit 93 generates the formation body data FD for providing the support in addition to the three-dimensional object Obj.

The support is preferably configured with a material which is easily removed after the formation of the three-dimensional object Obj, for example, water-soluble ink.

### 1.2. Three-Dimensional Object Formation Apparatus

Next, the three-dimensional object formation apparatus 1 will be described with reference to FIG. 3, in addition to FIG. 1. FIG. 3 is a perspective view schematically showing the inner structure of the three-dimensional object formation apparatus 1.

As shown in FIG. 1 and FIG. 3, the three-dimensional object formation apparatus 1 includes a housing 40, the formation table 45, a control unit 6 (an example of a “formation control unit”) which controls the operation of each unit of the three-dimensional object formation apparatus 1, a head unit 3 in which a recording head 30 including a discharging unit D discharging ink towards the formation table 45 is provided, a curing unit 61 which cures ink discharged onto the formation table 45, six ink cartridges 48, a carriage 41 on which the head unit 3 and the ink cartridges 48 are mounted, a position change mechanism 7 for changing the positions of the head unit 3, the formation table 45, and the curing unit 61 with respect to the housing 40, and a memory 60 which on which a control program of the three-dimensional object formation apparatus 1 or other various information items are recorded.

The control unit 6 and the formation data generation unit 93 function as a system control unit 101 which controls the operation of each unit of the three-dimensional object formation system 100.

The curing unit 61 is a constituent element for curing ink which is discharged onto the formation table 45, and a light source for emitting an ultraviolet ray to ultraviolet curable ink or a heater for heating resin ink can be exemplified, for example. When the curing unit 61 is a light source of an ultraviolet ray, the curing unit 61 is, for example, provided on the upper side (positive Z direction) of the formation table 45. Meanwhile, when the curing unit 61 is a superheater, the curing unit 61 may be, for example, embedded in the formation table 45 or provided on the lower side of the formation table 45.

Hereinafter, the description will be made by assuming that the curing unit 61 is a light source of an ultraviolet ray and the curing unit 61 is positioned in the positive Z direction of the formation table 45.

The six ink cartridges 48 are provided to correspond to a total of six types of ink including five colored formation inks for forming the three-dimensional object Obj and a supporting ink for forming the support, one by one. The type of ink corresponding to the ink cartridge 48 is filled in each ink cartridge 48.

The five colored formation ink for forming the three-dimensional object Obj include the chromatic ink including a chromatic color material component, the achromatic ink including an achromatic color material component, and clear (CL) ink having the content of the color material component per unit weight or unit volume which is smaller compared to the chromatic ink and the achromatic ink.

In the embodiment, as the chromatic ink, three colored ink of cyan (CY), magenta (MG), and yellow (YL) are used.

In the embodiment, white (WT) ink is used as the achromatic ink. When the light having a wavelength belonging to the wavelength area (approximately 400 nm to 700 nm) of a visible light is emitted to the white ink, the white ink according to the embodiment is ink which reflects a predetermined percentages or more light among the emitted light. The expression that “the predetermined percentage or more of light is reflected” has the same meaning as the expression that “less than the predetermined percentage or more of light is absorbed or transmitted”, and for example, corresponds to a case where the rate of the intensity of light reflected by the white ink with respect to the intensity of light emitted to the white ink is equal to or greater than the predetermined percentage. In the embodiment, the “predetermined percentage” may be, for example, an arbitrary percentage from 30% to 100%, preferably an arbitrary percentage equal to or greater than 50%, and more preferably an arbitrary percentage equal to or greater than 80%.

In the embodiment, the clear ink is ink having small content of a color material component and high transparency, compared to the chromatic ink and the achromatic ink.

Each ink cartridge 48 may be provided in separate places of the three-dimensional object formation apparatus 1, instead of being mounted on the carriage 41.

As shown in FIG. 1 and FIG. 3, the position change mechanism 7 includes a lift mechanism driving motor 71 for driving a formation table lift mechanism 79a which lifts the formation table 45 up and down in the positive Z direction and the negative Z direction (hereinafter, the positive Z direction and the negative Z direction may be collectively referred to as the “Z axis direction”), a carriage driving motor 72 for moving the carriage 41 along a guide 79b in a positive Y direction and a negative Y direction (hereinafter, the positive Y direction and the negative Y direction may be collectively referred to as the “Y axis direction”), a carriage driving motor 73 for moving the carriage 41 along a guide 79c in a positive X direction and a negative X direction (hereinafter, the positive X direction and the negative X direction may be collectively referred to as the “X axis direction”), and a curing unit driving motor 74 for moving the curing unit 61 along a guide 79d in the positive X direction and the negative X direction.

In addition, the position change mechanism 7 includes a motor driver 75 for driving the lift mechanism driving motor 71, a motor driver 76 for driving the carriage driving motor 72, a motor driver 77 for driving the carriage driving motor 73, and a motor driver 78 for driving the curing unit driving motor 74.

The memory 60 includes an electrically erasable programmable read-only memory (EEPROM) which is one kind of a nonvolatile semiconductor memory which stores the formation body data FD supplied from the host computer 9, a random access memory (RAM) which temporarily stores data which is necessary for executing various processes such as a formation process of forming the three-dimensional object Obj or temporarily develops a control program for controlling each unit of the three-dimensional object formation apparatus 1 so as to execute various processes such as the formation process, and a PROM which is one kind of a nonvolatile semiconductor memory which stores the control program.

The control unit 6 is configured to include a central processing unit (CPU) or a field-programmable gate array (FPGA) and controls the operation of each unit of the three-dimensional object formation apparatus 1 with the operation of the CPU which is performed along with the control program recorded on the memory 60.

The control unit 6 controls the operation of the head unit 3 and the position change mechanism 7 based on the formation body data FD supplied from the host computer 9 and accordingly, controls the execution of the formation process of forming the three-dimensional object Obj corresponding to the model data Dat on the formation table 45.

Specifically, first, the control unit 6 stores the formation body data FD supplied from the host computer 9 in the memory 60. Next, the control unit 6 generates various signals including a driving waveform signal Com and a waveform designation signal SI for driving the discharging unit D by controlling the operation of the head unit 3, based on various data recorded on the memory 60 such as the formation body data FD, and outputs the generated signals. In addition, the control unit 6 generates various signals for controlling the operations of the motor drivers 75 to 78 based on various data recorded on the memory 60 such as the formation body data FD, and outputs the generated signals.

The driving waveform signal Com is an analog signal. Accordingly, the control unit 6 includes a DA conversion signal (not shown) and converts a digital driving waveform signal generated in the CPU included in the control unit 6 into the analog driving waveform signal Com and then outputs the driving waveform signal.

As described above, the control unit 6 controls a relative position of the head unit 3 to the formation table 45 through the control of the motor drivers 75, 76, and 77 and controls a relative position of the curing unit 61 to the formation table 45 through the control of the motor drivers 75 and 78. In addition, the control unit 6 controls discharge or non-discharge of the ink from the discharging unit D, an amount of the ink discharged, and discharge timing of the ink through the control of the head unit 3.

Accordingly, the control unit 6 controls the execution of the lamination process of forming the dots on the formation table 45 and curing the dots formed on the formation table 45 to form the formation body LY, while adjusting the dot size and the dot arrangement regarding the dots which are formed by the ink discharged onto the formation table 45. In addition, the control unit 6 controls the execution of the formation process of laminating the new formation body LY on the formation body LY already formed by repeatedly executing the lamination process and accordingly forming the three-dimensional object Obj corresponding to the model data Dat.

As shown in FIG. 1, the head unit 3 includes the recording head 30 including M discharging units D and a driving signal generation unit 31 which generates driving signals Vin for driving the discharging units D (M is a natural number equal to or greater than 1).

Hereinafter, in order to differentiate each of the M discharging units D provided in the recording head 30, the discharging units may be referred to as first, second, . . . , M-th discharging unit, sequentially. In addition, hereinafter, an m-th discharging unit D among the M discharging units D provided in the recording head 30 may be expressed as a discharging unit D[m] (m is a natural number which satisfies an expression of 1≦m≦M). In addition, hereinafter, a driving signal Vin for driving the discharging unit D[m] among the driving signals generated by the driving signal generation unit 31 may be expressed as a driving signal Vin[m].

The driving signal generation unit 31 will be described later in detail.

### 1.3. Recording Head

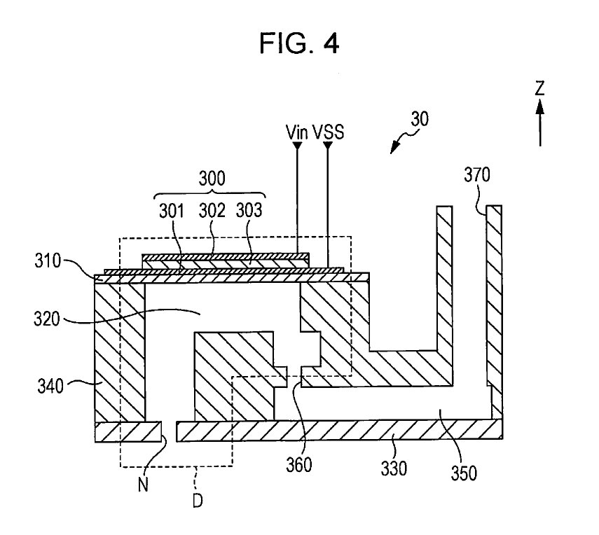

Next, the recording head 30 and the discharging units D provided in the recording head 30 will be described with reference to FIG. 4 to FIG. 6.

FIG. 4 is an example of a schematic partial sectional view of the recording head 30. In this drawing, for convenience of illustration, in the recording head 30, one discharging unit D among the M discharging units D included in the recording head 30, a reservoir 350 which is linked to the one discharging unit D through an ink supply port 360, and an ink inlet 370 for supplying the ink to the reservoir 350 from the ink cartridge 48 are shown.

As shown in FIG. 4, the discharging unit D includes a piezoelectric element 300, a cavity 320, inside of which is filled with the ink, a nozzle N which is linked to the cavity 320, and a vibration plate 310. The piezoelectric element 300 is driven by the driving signal Vin and accordingly the discharging unit D discharges the ink in the cavity 320 from the nozzle N. The cavity 320 is a space which is partitioned by a cavity plate 340 which is formed in a predetermined shape so as to have a recess, a nozzle plate 330 on which the nozzle N is formed, and the vibration plate 310. The cavity 320 is linked to the reservoir 350 through the ink supply port 360. The reservoir 350 is linked to one ink cartridge 48 through the ink inlet 370.

In the embodiment, a unimorph (monomorph) type as shown in FIG. 4 is used, for example, as the piezoelectric element 300. The piezoelectric element 300 is not limited to the unimorph type, and any type may be used such as a bimorph type or a lamination type, as long as the piezoelectric element 300 can be deformed to discharge the liquid such as ink.

The piezoelectric element 300 includes a lower electrode 301, an upper electrode 302, and a piezoelectric body 303 which is provided between the lower electrode 301 and the upper electrode 302. When a potential of the lower electrode 301 is set as a predetermined reference potential VSS, the driving signal Vin is supplied to the upper electrode 302, and accordingly, a voltage is applied between the lower electrode 301 and the upper electrode 302, the piezoelectric element 300 is bent (displaced) in a vertical direction of the drawing according to the applied voltage and as a result, the piezoelectric element 300 is vibrated.

The vibration plate 310 is installed on the upper opening of the cavity plate 340 and the lower electrode 301 is bonded to the vibration plate 310. Accordingly, when the piezoelectric element 300 is vibrated by the driving signal Vin, the vibration plate 310 is also vibrated. The volume of the cavity 320 (pressure in the cavity 320) changes according to the vibration of the vibration plate 310 and the ink filled in the cavity 320 is discharged by the nozzle N. When the ink in the cavity 320 is decreased due to the discharge of the ink, the ink is supplied from the reservoir 350. In addition, the ink is supplied to the reservoir 350 from the ink cartridge 48 through the ink inlet 370.

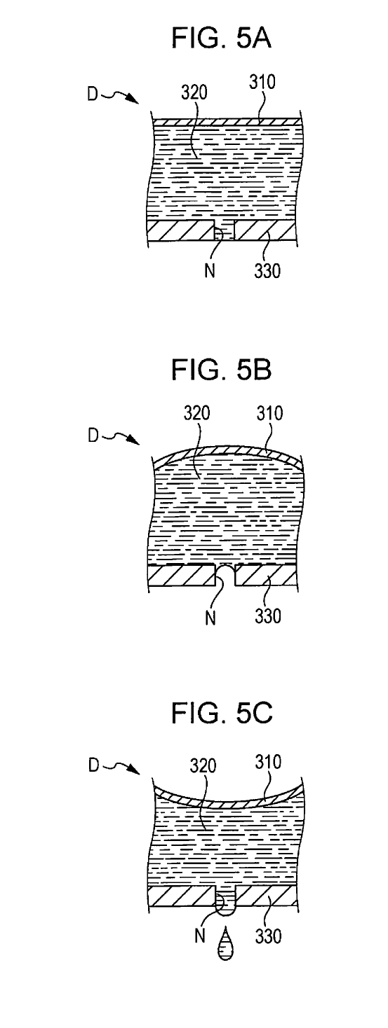

FIGS. 5A to 5C are explanatory diagrams illustrating a discharging operation of the ink from the discharging unit D. In a state shown in FIG. 5A, when the driving signal Vin is supplied to the piezoelectric element 300 included in the discharging unit D from the driving signal generation unit 31, distortion according to an electric field applied between the electrodes occurs in the piezoelectric element 300 and the vibration plate 310 of the discharging unit D is bent in the vertical direction of the drawing. Accordingly, as shown in FIG. 5B, the volume of the cavity 320 of the discharging unit D is expanded, compared to the initial state shown in FIG. 5A. In the state shown in FIG. 5B, when the potential shown by the driving signal Vin is changed, the vibration plate 310 is restored by an elastic restoring force and is moved downwards of the drawing by passing the position of the vibration plate 310 in the initial state, and the volume of the cavity 320 is rapidly contracted as shown in FIG. 5C. At that time, some ink filled in the cavity 320 is discharged as ink droplets from the nozzle N which is linked to the cavity 320, due to compression pressure generated in the cavity 320.

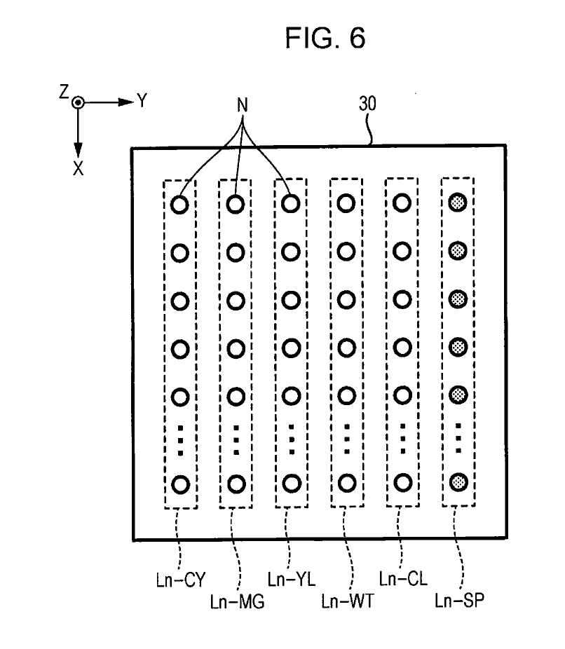

FIG. 6 is an explanatory diagram for illustrating an example of arrangement of M nozzles N provided in the recording head 30 in a plan view of the three-dimensional object formation apparatus 1 in a positive Z direction or a negative Z direction.

As shown in FIG. 6, in the recording head 30, six nozzle arrays Ln formed of a nozzle array Ln-CY formed of a plurality of nozzles N, a nozzle array Ln-MG formed of a plurality of nozzles N, a nozzle array Ln-YL formed of a plurality of nozzles N, a nozzle array Ln-WT formed of a plurality of nozzles N, a nozzle array Ln-CL formed of a plurality of nozzles N, and a nozzle array Ln-SP formed of a plurality of nozzles N, are provided.

Herein, the nozzle N belonging to the nozzle array Ln-CY is a nozzle N provided in the discharging unit D for discharging the cyan (CY) ink, the nozzle N belonging to the nozzle array Ln-MG is a nozzle N provided in the discharging unit D for discharging the magenta (MG) ink, the nozzle N belonging to the nozzle array Ln-YL is a nozzle N provided in the discharging unit D for discharging the yellow (YL) ink, the nozzle N belonging to the nozzle array Ln-WT is a nozzle N provided in the discharging unit D for discharging the white (WT) ink, the nozzle N belonging to the nozzle array Ln-CL is a nozzle N provided in the discharging unit D for discharging the clear (CL) ink, and the nozzle N belonging to the nozzle array Ln-SP is a nozzle N provided in the discharging unit D for discharging the supporting ink.

In the embodiment, as shown in FIG. 6, a case where the plurality of nozzles N configuring each nozzle array Ln are arranged to be lined up in a line in the X axis direction has been used, but for example, the nozzles may be arranged in a so-called zigzag manner in which the positions of some nozzles N (for example, the even-numbered nozzles N) of the plurality of nozzles N configuring each nozzle array Ln and the positions of the other nozzles N (for example, odd-numbered nozzles N) are different from each other in the Y axis direction.

In addition, in each nozzle array Ln, a gap (pitch) between the nozzles N can be appropriately set according to the printing resolution (dpi: dot per inch).

### 1.4. Driving Signal Generation Unit

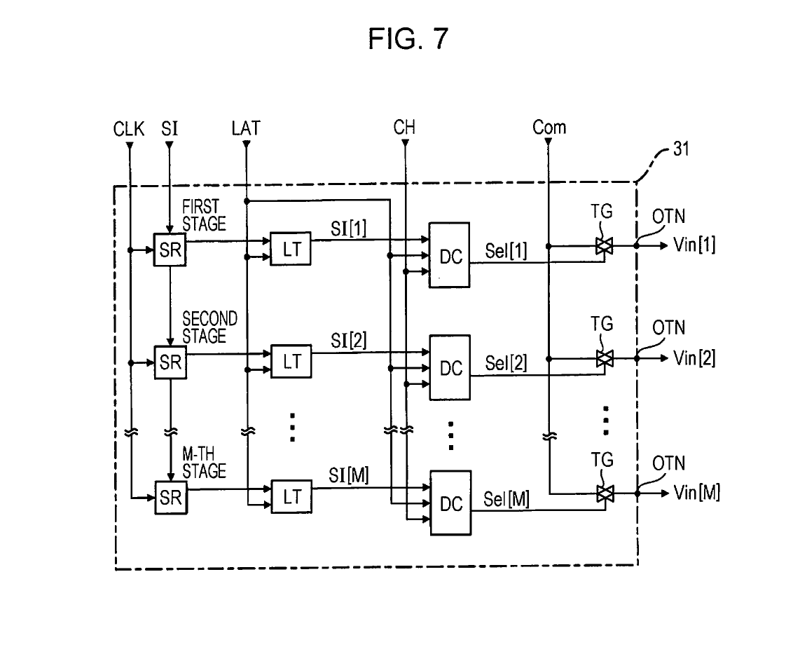

Next, the configuration and the operation of the driving signal generation unit 31 will be described with reference to FIG. 7 to FIG. 9.

FIG. 7 is a block diagram showing the configuration of the driving signal generation unit 31.

As shown in FIG. 7, the driving signal generation unit 31 includes M sets consisting of a shift resistor SR, a latch circuit LT, a decoder DC, and a transmission gate TG so as to respectively correspond to the M discharging units D provided in the recording head 30. Hereinafter, each element configuring the M sets included in the driving signal generation unit 31 and the recording head 30 is referred to as a first, second, . . . , and M-th element in the order from the top of the drawing.

A clock signal CLK, the waveform designation signal SI, a latch signal LAT, a change signal CH, and the driving waveform signal Com are supplied to the driving signal generation unit 31 from the control unit 6.

The waveform designation signal SI is a digital signal which designates an ink amount to be discharged by the discharging unit D and includes the waveform designation signals SI[1] to SI[M].

Among these, a waveform designation signal SI[m] regulates discharge or non-discharge of the ink from the discharging unit D[m] and the amount of the ink discharged with two bits of a high-order bit b1 and a low-order bit b2. Specifically, the waveform designation signal SI[m] regulates any one of discharging of ink of an amount corresponding to a large dot, discharging of ink of an amount corresponding to a medium dot, discharging of ink of an amount corresponding to a small dot, and non-discharging of ink, regarding the discharging unit D[m].

Each shift resistor SR temporarily holds the waveform designation signal SI[m] of two bits corresponding to each stage among the waveform designation signals SI (SI[1] to SI[M]). Specifically, the first, second, . . . , and M-th M shift resistors SR respectively corresponding to the M discharging units D[1] to D[M] are cascade-connected to each other, and the waveform designation signals SI supplied in serial order are transmitted in the order according to the clock signal CLK. When the waveform designation signals SI are transmitted to all of the M shift resistors SR, each of the M shift resistors SR holds the corresponding waveform designation signal SI[m] of 2 bits among the waveform designation signals SI.

Each of the M latch circuits LT simultaneously latches the waveform designation SI[m] of 2 bits corresponding to each stage held by each of the M shift resistors SR, at a timing when the latch signal LAT rises.

However, an operation period which is a period for executing the formation process by the three-dimensional object formation apparatus 1 is configured from a plurality of unit periods Tu. In the embodiment, each unit period Tu is formed of three control periods Ts (Ts1 to Ts3). In the embodiment, the three control periods Ts1 to Ts3 have a duration equivalent to each other. Although will be described later in detail, the unit period Tu is regulated by the latch signal LAT, and the control period Ts is regulated by the latch signal LAT and the change signal CH.

The control unit 6 supplies the waveform designation signal SI to the driving signal generation unit 31 at a timing before the unit period Tu is started. The control unit 6 supplies the latch signal LAT to each latch circuit LT of the driving signal generation unit 31 so that the waveform designation signal SI[m] is latched in each unit period Tu.

The m-th decoder DC decodes the waveform designation signal SI[m] of 2 bits which is latched by the m-th latch circuit LT and outputs a selection signal Sel[m] which is set as any level of a high level (H level) and a low level (L level) in each of the control periods Ts1 to Ts3.

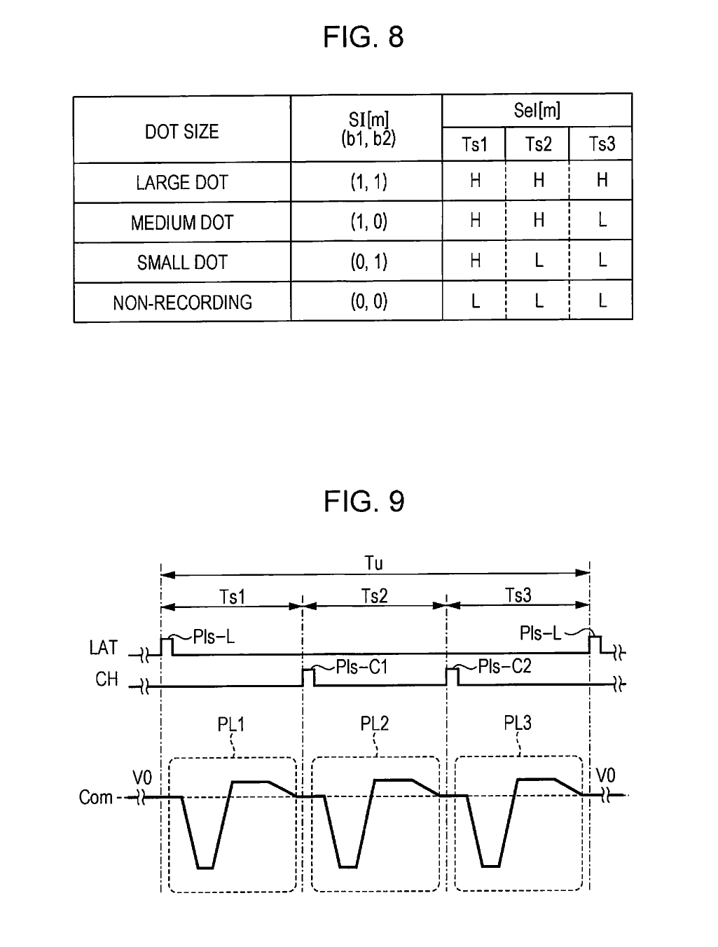

FIG. 8 is an explanatory diagram for illustrating the content of the decoding performed by the decoder DC.

As shown in the drawing, when the content shown by the waveform designation signal SI[m] is (b1,b2)=(1,1), the m-th decoder DC sets the selection signal Sel[m] as the H level in the control periods Ts1 to Ts3, when the content shown by the waveform designation signal SI[m] is (b1,b2)=(1,0), the m-th decoder DC sets the selection signal Sel[m] as the H level in the control periods Ts1 and Ts2 and sets the selection signal Sel[m] as the L level in the control period Ts3, when the content shown by the waveform designation signal SI[m] is (b1,b2)=(0,1), the m-th decoder DC sets the selection signal Sel[m] as the H level in the control period Ts1 and sets the selection signal Sel[m] as the L level in the control periods Ts2 and Ts3, and when the content shown by the waveform designation signal SI[m] is (b1,b2)=(0,0), the m-th decoder DC sets the selection signal Sel[m] as the L level in the control periods Ts1 to Ts3.

As shown in FIG. 7, the M transmission gates TG included in the driving signal generation unit 31 are provided so as to correspond to the M discharging units D included in the recording head 30.

The m-th transmission gate TG is turned on when the selection signal Sel[m] output from the m-th decoder DC is in the H level and is turned off when the selection signal is in the L level. The driving waveform signal Com is supplied to one terminal of each transmission gate TG. The other terminal of the m-th transmission gate TG is electrically connected to an m-th output terminal OTN.

When the selection signal Sel[m] is set as the H level and the m-th transmission gate TG is turned on, the driving waveform signal Com is supplied from the m-th output terminal OTN to the discharging unit D[m] as the driving signal Vin[m].

Although will be described later in detail, in the embodiment, a potential of the driving waveform signal Com at a timing when the state of the transmission gate TG is switched from on to off (that is, timing of the start and the end of the control periods Ts1 to Ts3) is set as a reference potential V0. Accordingly, when the transmission gate TG is turned off, the potential of the output terminal OTN is maintained as the reference potential V0 by the volume or the like of the piezoelectric element 300 of the discharging unit D[m]. Hereinafter, for convenience of description, the description will be made by assuming that, when the transmission gate TG is turned off, the potential of the driving signal Vin[m] is maintained as the reference potential V0.

As described above, the control unit 6 controls the driving signal generation unit 31 so that the driving signal Vin is supplied to each discharging unit D in each unit period Tu. Accordingly, each discharging unit D can discharge the amount of ink corresponding to a value shown by the waveform designation signal SI determined based on the formation body data FD in each unit period Tu and can form dots corresponding to the formation body data FD on the formation table 45.

FIG. 9 is a timing chart for illustrating various signals supplied to the driving signal generation unit 31 by the control unit 6 in each unit period Tu.

As shown in FIG. 9, the latch signal LAT includes a pulse waveform Pls-L and the unit period Tu is regulated by the pulse waveform Pls-L. In addition, the change signal CH includes a pulse waveform Pls-C and the unit period Tu is divided into the control periods Ts1 to Ts3 by the pulse waveform Pls-C. Although not shown in the drawing, the control unit 6 synchronizes the waveform designation signal SI with the clock signal CLK in each unit period Tu and supplies the signal to the driving signal generation unit 31 in serial order.

As shown in FIG. 9, driving waveform signal Com includes a waveform PL1 disposed in the control period Ts1, a waveform PL2 disposed in the control period Ts2, and a waveform PL3 disposed in the control period Ts3. Hereinafter, the waveforms PL1 to PL3 may be collectively referred to as the waveform PL. In the embodiment, the potential of the driving waveform signal Com is set as the reference potential V0 at the timing of the start or the end of each control period Ts.

When the selection signal Sel[m] is in the H level in one control period Ts, the driving signal generation unit 31 supplies the waveform PL disposed in the one control period Ts in the driving waveform signal Com to the discharging unit D[m] as the driving signal Vin[m]. On the other hand, when the selection signal Sel[m] is in the L level in one control period Ts, the driving signal generation unit 31 supplies the driving waveform signal Com which is set as the reference potential V0 to the discharging unit D[m] as the driving signal Vin[m].

Accordingly, regarding the driving signal Vin[m] supplied by the driving signal generation unit 31 to the discharging unit D[m] in the unit period Tu, when the value shown by the waveform designation signal SI[m] is (b1,b2)=(1,1), the driving signal is a signal including the waveforms PL1 to PL3, when the value shown by the waveform designation signal SI[m] is (b1,b2)=(1,0), the driving signal is a signal including the waveforms PL1 and PL2, when the value shown by the waveform designation signal SI[m] is (b1,b2)=(0,1), the driving signal is a signal including the waveform PL1, and when the value shown by the waveform designation signal SI[m] is (b1,b2)=(0,0), the driving signal is a signal which is set as the reference potential V0.

When the driving signal Vin[m] including one waveform PL is supplied, the discharging unit D[m] discharges a small amount of ink and forms a small dot.

Accordingly, when the value shown by the waveform designation signal SI[m] is (b1,b2)=(0,1) and the driving signal Vin[m] supplied to the discharging unit D[m] includes one waveform PL (PL1) in the unit period Tu, a small amount of ink is discharged from the discharging unit D[m] based on the one waveform PL, and a small dot is formed with the discharged ink.

When the value shown by the waveform designation signal SI[m] is (b1,b2)=(1,0) and the driving signal Vin[m] supplied to the discharging unit D[m] includes two waveforms PL (PL1 and PL2) in the unit period Tu, a small amount of ink is discharged from the discharging unit D[m] twice based on the two waveforms PL, the small amounts of ink which are discharged twice are combined to each other, and accordingly a medium dot is formed.

When the value shown by the waveform designation signal SI[m] is (b1,b2)=(1,1) and the driving signal Vin[m] supplied to the discharging unit D[m] includes three waveforms PL (PL1 to PL3) in the unit period Tu, a small amount of ink is discharged from the discharging unit D[m] three times based on the three waveforms PL, the small amounts of ink which are discharged three times are combined to each other, and accordingly a large dot is formed.

Meanwhile, when the value shown by the waveform designation signal SI[m] is (b1,b2)=(0,0) and the driving signal Vin[m] supplied to the discharging unit D[m] does not include the waveform PL and is maintained as the reference potential V0 in unit period Tu, the ink is not discharged from the discharging unit D[m] and the dot is not formed (the recording is not performed).

In the embodiment, as clearly described above, the medium dot has a size which is double the size of the small dot and the large dot has a size which is three times of that of the small dot.

In the embodiment, the waveform PL of the driving waveform signal Com is determined so that the small amount of ink discharged for forming a small dot is an amount which is approximately ⅓ of the ink necessary for forming a unit structure. That is, the unit structure is configured with any one of three patterns of one large dot, a combination of one medium dot and one small dot, and a combination of three small dots.

In the embodiment, one unit structure is provided with respect to one voxel Vx. That is, in the embodiment, the dots are formed in one voxel Vx with any one of three patterns of one large dot, a combination of one medium dot and one small dot, and a combination of three small dots.

### 2. Data Generation Process and Formation Process

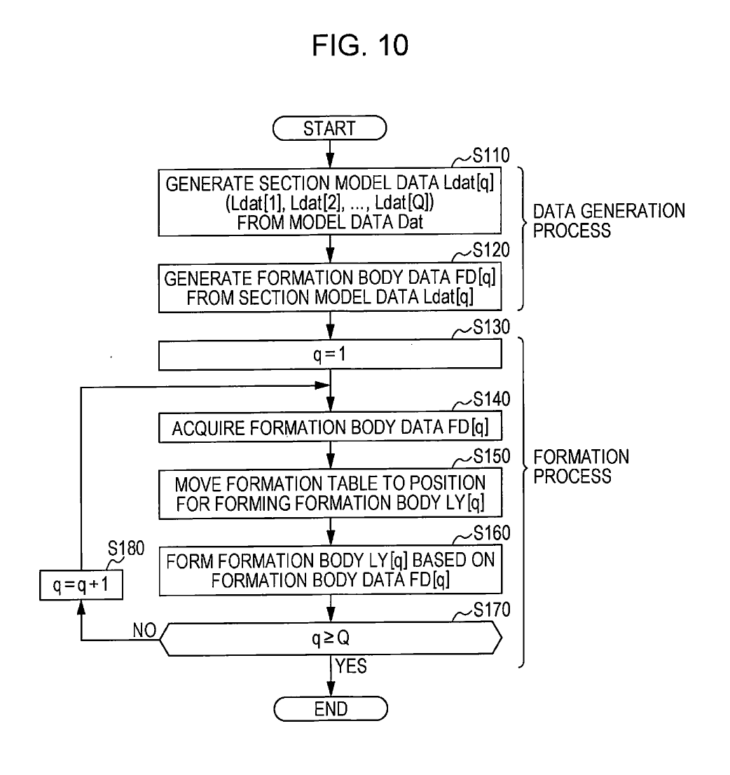

Next, the data generation process and the formation process executed by the three-dimensional object formation system 100 will be described with reference to FIG. 10 to FIG. 14.

### 2.1. Outline of Data Generation Process and Formation Process

FIG. 10 is a flowchart showing an example of the operation of the three-dimensional object formation system 100 when the data generation process and the formation process are executed.

The data generation process is a process executed by the formation data generation unit 93 of the host computer 9 and is started when the model data Dat output by the model data generation unit 92 is acquired by the formation data generation unit 93. The processes in Steps S110 and S120 shown in FIG. 10 correspond to the data generation process.

As shown in FIG. 10, when the data generation process is started, the formation data generation unit 93 generates section model data items Ldat[q] (Ldat[1] to Ldat[Q]) based on the model data Dat output by the model data generation unit 92 (S110). As described above, in Step S110, the formation data generation unit 93 executes the shape complementation process which is a process of complementing the hollow portion having the shape shown by the model data Dat and generating the section model data Ldat so that a part of or the entire area of the inside of the three-dimensional object Obj is a solid shape. The shape complementation process will be described later in detail.

Then, the formation data generation unit 93 determines the arrangement of the dots to be formed by the three-dimensional object formation apparatus 1 for forming the formation body LY[q] corresponding to the shape and the color shown by the section model data Ldat[q] and outputs the determined result as the formation body data FD[q] (S120).

As described above, the formation data generation unit 93 executes the data generation process shown in Steps S110 and S120 of FIG. 10.

The three-dimensional object formation system 100 executes the formation process after executing the data generation process.

The formation process is a process executed by the three-dimensional object formation apparatus 1 under the control of the control unit 6 and is started when the formation body data FD output by the host computer 9 is acquired by the three-dimensional object formation apparatus 1. The processes in Steps S130 to S180 shown in FIG. 10 correspond to the formation process.

As shown in FIG. 10, the control unit 6 sets “1” for a variable q showing the number of times of execution of the lamination process (S130). Next, the control unit 6 acquires a formation body data FD[q] generated by the formation data generation unit 93 (S140). The control unit 6 controls the lift mechanism driving motor 71 so that the formation table 45 moves to a position for forming the formation body LY[q] (S150).

For the position of the formation table 45 for forming the formation body LY[q], any position may be used as long as it is a position where the ink discharged from the head unit 3 can be properly landed on a dot formation position (voxel Vxq) designated by the formation body data FD[q]. For example, in Step S150, the control unit 6 may control the position of the formation table 45 so that a space between the formation body LY[q] and the head unit 3 in the Z axis direction is constant. In this case, the control unit 6, for example, may move the formation table 45 in the negative Z direction by an amount of the predetermined thickness ΔZ during the time after the formation body LY[q] is formed in the q-th lamination process and before the formation of the formation body LY[q+1] in the (q+1)-th lamination process is started.

After moving the formation table 45 to a position for forming the formation body LY[q], the control unit 6 controls the operations of the head unit 3, the position change mechanism 7, and the curing unit 61 so that the formation body LY[q] is formed based on the formation body data FD[q] (S160). As clearly described in FIGS. 2A to 2E, the formation body LY[1] is formed on the formation table 45 and the formation body LY[q+l] is formed on the formation body LY[q].

After that, the control unit 6 determines whether or not the variable q satisfies an expression of “q≧Q” (S170). When the determined result is positive, it is determined that the formation of the three-dimensional object Obj is completed and the formation process is finished, and meanwhile, when the determined result is negative, 1 is added to the variable q and the process proceeds to Step S140 (s180).

As described above, the three-dimensional object formation apparatus 1 executes the formation process shown in Steps S130 to S180 of FIG. 10.

That is, by executing the data generation process shown in Steps S110 and S120 of FIG. 10, the three-dimensional object formation system 100 generates the formation body data items FD[1] to FD[Q] based on the model data Dat, and by executing the formation process shown in Steps S130 to S180 of FIG. 10, the three-dimensional object formation system forms the three-dimensional object Obj based on the formation body data items FD[1] to FD[Q].

FIG. 10 is merely an example of the flow of the data generation process and the formation process. For example, in FIG. 10, the formation process is started after completing the data generation process, but the invention is not limited to this embodiment, and the formation process may be started before completing the data generation process. For example, when the formation body data FD[q] is generated in the data generation process, the formation process (that is, the q-th lamination process) of forming the formation body LY[q] may be executed based on the formation body data FD[q], without waiting for the generation of the next formation body data FD[q+1].

### 2.2. Shape Complementation Process

As described above, in Step S110, the formation data generation unit 93 executes the shape complementation process of complementing a part of or the entire hollow portion having shape shown by the model data Dat and generating the section model data Ldat so that a part or the entirety of the inside of the three-dimensional object Obj has a solid structure.

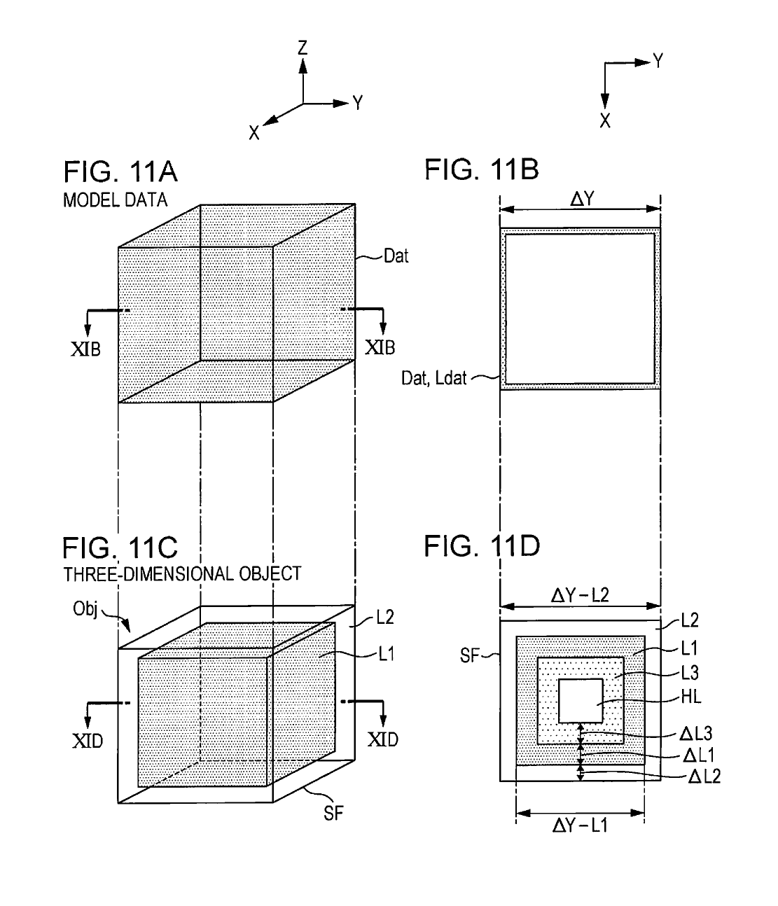

Hereinafter, the inner structure of the three-dimensional object Obj generated based on the section model data Ldat and the shape complementation process of determining the inner structure of the three-dimensional object Obj will be described with reference to FIG. 11A to FIG. 15C.

First, the inner structure of the three-dimensional object Obj formed by the three-dimensional object formation system 100 according to the embodiment will be described with reference to FIGS. 11A to 11D.

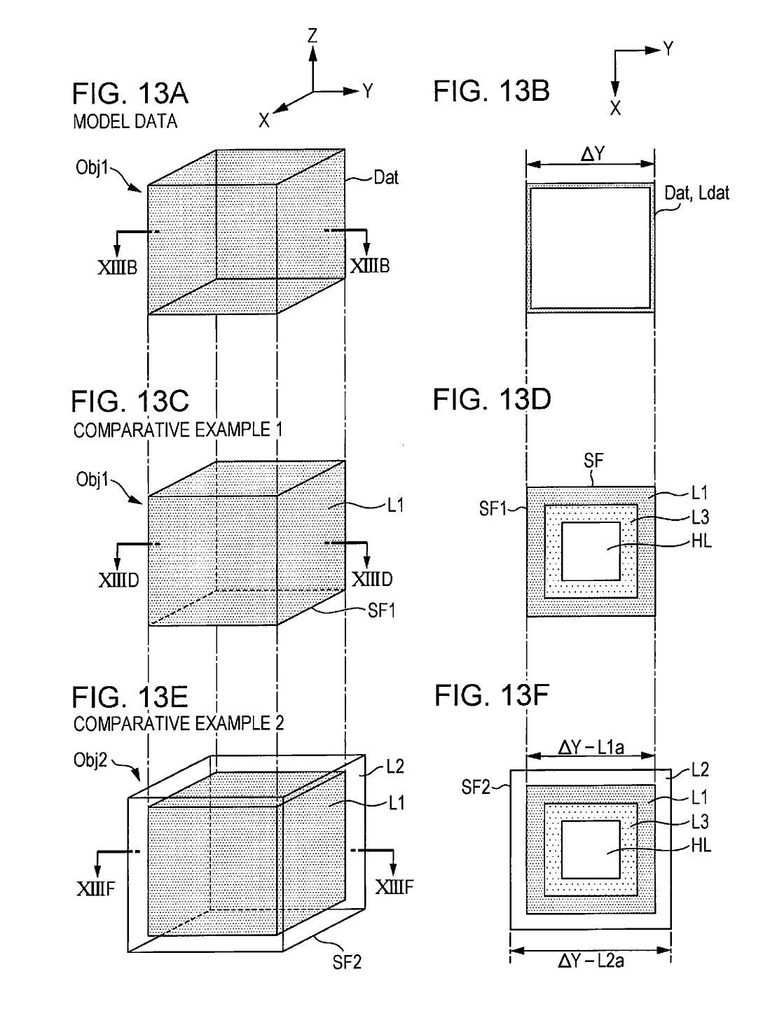

FIG. 11A is a perspective view showing a model of the three-dimensional object Obj designated by the model data Dat and FIG. 11B is a sectional view when the model of the three-dimensional object Obj designated by the model data Dat is sectioned along a plane parallel to the X axis and the Y axis through a linear line XIB-XIB of FIG. 11A. FIG. 11C is a perspective view showing the three-dimensional object Obj formed by the three-dimensional object formation apparatus 1 and FIG. 11D is a sectional view when the three-dimensional object Obj formed by the three-dimensional object formation apparatus 1 is sectioned along a plane parallel to the X axis and the Y axis through a linear line XID-XID of FIG. 11C. In FIGS. 11A to 11D and FIGS. 13A to 13F which will be described later, for convenience of illustration, a case of forming the cuboid three-dimensional object Obj having a shape different from that shown in FIGS. 2A to 3 is assumed.

As shown in FIGS. 11C and 11D, the three-dimensional object formation apparatus 1 forms the three-dimensional object Obj so as to provide three layers of a transparent layer L2, a chromatic layer L1, and a white layer L3 in the order from the outer surface SF which is an outline of the three-dimensional object Obj to the inside of the three-dimensional object Obj and to further provides a hollow portion HL in the inside with respect to the three layers. That is, the three-dimensional object formation apparatus 1 forms the three-dimensional object Obj so as to provide the chromatic layer L1, the transparent layer L2, and the white layer L3 between the outer surface of the three-dimensional object Obj and the hollow portion HL.

More specifically, as clearly shown in FIG. 11D, the surface on the outer side of the transparent layer L2 is set as the outer surface SF of the three-dimensional object Obj, the transparent layer L2 is provided so as to separate the outer surface SF and the chromatic layer L1, the chromatic layer L1 is provided so as to separate the transparent layer L2 and the white layer L3, and the white layer L3 is provided so as to separate the chromatic layer L1 and the hollow portion HL. Accordingly, the outer side (outer surface SF side) of the hollow portion HL is covered with the white layer L3, the surface on the outer side of the white layer L3 (surface on the outer surface SF side) is covered with the chromatic layer L1, and the surface on the outer side of the chromatic layer L1 is covered with the transparent layer L2.

Herein, the chromatic layer L1 is a layer which is formed using the formation ink including at least chromatic ink and is a layer for expressing the color of the three-dimensional object Obj. The transparent layer L2 is a layer formed using the clear ink and is a layer provided so as to cover the chromatic layer L1 in order to protect the chromatic layer L1. The white layer L3 is a layer formed using the white ink and is a layer for preventing the color on the inner portion of the three-dimensional object Obj with respect to the chromatic layer L1 from being visualized from the outside of the three-dimensional object Obj through the chromatic layer L1.

In the embodiment, each layer is provided so that the chromatic layer L1 has a uniform thickness ΔL1, the transparent layer L2 has a uniform thickness ΔL2, and the white layer L3 has a uniform thickness ΔL3.

In the embodiment, the transparent layer L2 is formed so that the thickness ΔL2 of the transparent layer L2 is greater than any one of a height, a width, and a depth of at least one voxel Vx. Accordingly, in the embodiment, the formation body LY[1] formed in the first lamination process and the formation body LY[Q] formed in the Q-th lamination process are set as the transparent layer L2, among the formation bodies LY[1] to LY[Q] configuring the three-dimensional object Obj.

As shown in FIGS. 11A to 11D, three-dimensional object formation apparatus 1 forms the three-dimensional object Obj so that the three-dimensional object Obj and the model of the three-dimensional object Obj shown by the model data Dat have approximately the same size. That is, the three-dimensional object formation apparatus 1 forms the three-dimensional object Obj so that the size and the shape of the outer surface SF of the three-dimensional object Obj and the size and the shape of the model shown by the model data Dat are approximately the same. That is, in the embodiment, the size and the shape of the enclosed space having the surface of the outer side of the transparent layer L2 as a boundary are approximately the same as the size and the shape of the model shown by the model data Dat. For example, as shown in FIGS. 11B and 11D, in the embodiment, a length ΔY of the model shown by the model data Dat in the Y axis direction and a length ΔY-L2 of the outer surface SF which is a surface on the outer side of the transparent layer L2 of the three-dimensional object Obj formed by the three-dimensional object formation apparatus 1 in the Y axis direction are approximately the same.

The expression of “approximately the same” in this specification includes a case where the state can be assumed as the same when ignoring various errors, in addition to a case where the state is completely the same. The various errors which can be ignored include a discrete error generated when the shape shown by the model data Dat is represented as an assembly of the voxels Vx. When the shape of the model shown by the model data Dat and the shape shown by the three-dimensional object Obj can be assumed as approximately the same, when ignoring the various errors generated when the shape shown by the model data Dat is represented as an assembly of the voxels Vx, it is possible to express that the shape of the model shown by the model data Dat and the shape of the three-dimensional object Obj are approximately the same.

However, the pattern or the like represented as the color of the model shown by the model data Dat are represented with the chromatic layer L1 in the three-dimensional object Obj. Accordingly, in order to represent the pattern or the like shown by the model data Dat in the three-dimensional object Obj as it is, it is necessary that the enclosed space having the surface on the outer side of the chromatic layer L1 as a boundary and the model shown by the model data Dat have approximately the same size and shape.

However, as described above, the chromatic layer L1 is formed on the inner side with respect to the outer surface SF by a distance corresponding to the thickness ΔL2 of the transparent layer L2. That is, the size of the enclosed space having the surface on the outer side of the chromatic layer L1 as a boundary and the size of the model shown by the model data Dat are different from each other. For example, as shown in FIGS. 11B and 11D, a length ΔY-L1 of the surface on the outer side of the chromatic layer L1 in the Y axis direction is shorter than the length ΔY of the model shown by the model data Dat in the Y axis direction.

Therefore, in the embodiment, the section model data Ldat is formed by contracting the pattern of the model shown by the model data Dat at a rate of contracting the size of the three-dimensional object Obj as the size obtained by removing the transparent layer L2 from the three-dimensional object Obj. Accordingly, the pattern of the model shown by the model data Dat can be represented using the surface on the outer side of the chromatic layer L1.

However, strictly, the shape of the enclosed space having the surface on the outer side of the chromatic layer L1 as a boundary and the shape of the model shown by the model data Dat may not be similar to each other. In this case, the pattern represented as the chromatic layer L1 and the pattern shown by the model data Dat are different shapes having different aspect ratios, and when a degree of a difference between the shapes is great, the difference may be visualized as distorted pattern. However, in general, the thickness ΔL2 of the transparent layer L2 is sufficiently smaller than the size of the three-dimensional object Obj. Accordingly, in general, a degree of a difference between the shapes of the enclosed space having the surface on the outer side of the chromatic layer L1 as a boundary and the model shown by the model data Dat is small and it is possible to assume that the both shapes are similar to each other.

With the above reasons, in the embodiment, the shape of the pattern represented as the chromatic layer L1 of the three-dimensional object Obj and the shape of the pattern shown by the model data Dat are assumed to be approximately the same to each other.

In the embodiment, the size of the pattern shown by the model data Dat is contracted by the thickness ΔL2 of the transparent layer L2 and the contracted pattern is represented as the chromatic layer L1, but the invention is not limited to this embodiment. For example, without contracting the size of the pattern shown by the model data Dat, the pattern may be moved in parallel to a normal direction of the outer surface SF which is a direction facing the inner side of the three-dimensional object Obj and the parallel-moved pattern may be displayed in the chromatic layer L1.

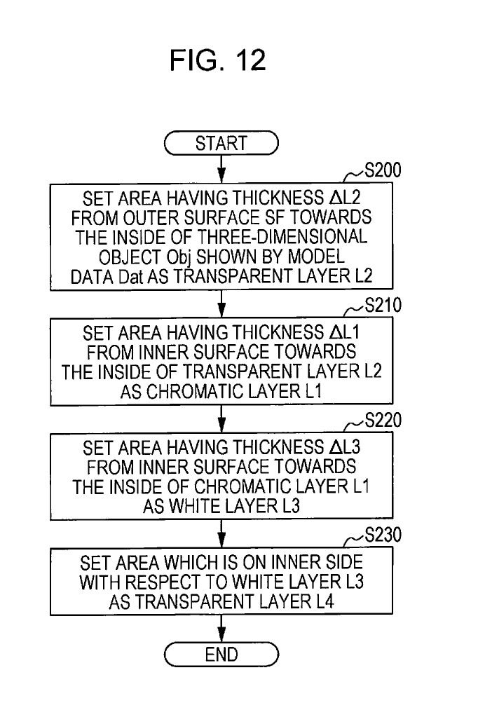

FIG. 12 is a flowchart showing an example of the operation of the formation data generation unit 93 when executing the shape complementation process.

As shown in FIG. 12, the formation data generation unit 93 first determines an area having the thickness ΔL2 from the outer surface SF of the three-dimensional object Obj to the inner side of the three-dimensional object Obj in the model of the three-dimensional object Obj represented by the model data Dat, as the transparent layer L2 (S200). The formation data generation unit 93 determines the area having the thickness ΔL1 from the surface on the inner side of the transparent layer L2 to the inner side of the three-dimensional object Obj as the chromatic layer L1 (S210). The formation data generation unit 93 determines the area having the thickness ΔL3 from the surface on the inner side of the chromatic layer L1 to the inner side of the three-dimensional object Obj as the white layer L3 (S220). The formation data generation unit 93 determines the portion on the inner side of the three-dimensional object Obj with respect to the white layer L3 as the hollow portion HL (S230).

The formation data generation unit 93 generates the section model data Ldat for forming the three-dimensional object Obj including the chromatic layer L1, the transparent layer L2, and the white layer L3 shown in FIGS. 11B and 11D, by executing the shape complementation process described above.

### 2.3. Comparative Examples

As described above, in the three-dimensional object formation system 100 according to the embodiment, the size of the three-dimensional object Obj and the size of the model shown by the model data Dat are approximately the same and the three-dimensional object Obj is formed so that the outer side of the chromatic layer L1 is covered with the transparent layer L2. Hereinafter, in order to make the advantages of the formation of the three-dimensional object Obj by the three-dimensional object formation system 100 according to the embodiment clear, a three-dimensional object formation system according to Comparative Example 1 and Comparative Example 2 will be described.

FIGS. 13A to 13F are diagrams showing a three-dimensional object formed by the three-dimensional object formation system according to Comparative Example 1 and Comparative Example 2. Among these, FIG. 13A is a perspective view of a model shown by the model data Dat in the same manner as FIG. 11A and FIG. 13B is a sectional view of the model shown by the model data Dat in the same manner as FIG. 11B. FIG. 13C is a perspective view showing a three-dimensional object Obj1 formed by a three-dimensional object formation apparatus included in the three-dimensional object formation system according to Comparative Example 1 and FIG. 13D is a sectional view when the three-dimensional object Obj1 is sectioned along a plane parallel to the X axis and the Y axis through a linear line XIIID-XIIID of FIG. 13C. FIG. 13E is a perspective view showing a three-dimensional object Obj2 formed by a three-dimensional object formation apparatus included in the three-dimensional object formation system according to Comparative Example 2 and FIG. 13F is a sectional view when the three-dimensional object Obj2 is sectioned along a plane parallel to the X axis and the Y axis through a linear line XIIIF-XIIIF of FIG. 13E.

As shown in FIGS. 13C and 13D, the three-dimensional object Obj1 formed by the three-dimensional object formation system according to Comparative Example 1 is formed so that a surface on the outer side of the chromatic layer L1 is an outer surface SF1 of the three-dimensional object Obj. That is, in the three-dimensional object Obj1 according to Comparative Example 1, the chromatic layer L1 is exposed without providing the transparent layer L2 for protecting the chromatic layer L1. As described above, the number of color material components of the chromatic ink included in the formation ink used for forming the chromatic layer L1 is greater than that of the clear ink used for forming the transparent layer L2. Accordingly, it is difficult to increase the strength of the chromatic layer L1 compared to the transparent layer L2 and the chromatic layer L1 may be peeled off due to deterioration over time.

With respect to this, the outer side of the chromatic layer L1 of the three-dimensional object Obj formed by the three-dimensional object formation system 100 according to the embodiment is covered with the transparent layer L2 having higher strength than that of the chromatic layer L1, and accordingly, it is possible to prevent the peeling-off of the chromatic layer L1 due to deterioration over time and to maintain a state where the color of the three-dimensional object Obj shown by the model data Dat is properly displayed for a long time.

As shown in FIGS. 13E and 13F, the three-dimensional object Obj2 formed by the three-dimensional object formation system according to Comparative Example 2 is formed so that the transparent layer L2 is provided on the outer side of the chromatic layer L1 so as to cover the chromatic layer L1 and a surface on the outer side of the transparent layer L2 is an outer surface SF2 of the three-dimensional object Obj2.

The three-dimensional object Obj2 is formed so that the size and the shape of the enclosed space having the surface of the outer side of the chromatic layer L1 as a boundary are approximately the same as the size and the shape of the model of the three-dimensional object Obj shown by the model data Dat. That is, the size of the three-dimensional object Obj2 is greater than the size of the model of the three-dimensional object Obj shown by the model data Dat. For example, as shown in FIG. 13F, in the three-dimensional object Obj2 according to Comparative Example 2, since a length ΔY-L1a of the surface on the outer side of the chromatic layer L1 in the Y axis direction and the length ΔY of the model shown by the model data Dat in the Y axis direction are approximately the same, a length ΔY-L2a of the outer surface SF2 which is a surface on the outer side of the transparent layer L2 in the Y axis direction is greater than the length ΔY. That is, the three-dimensional object formation system 100 according to Comparative Example 2 forms the three-dimensional object Obj2 having the larger size than that the size shown by the model data Dat.

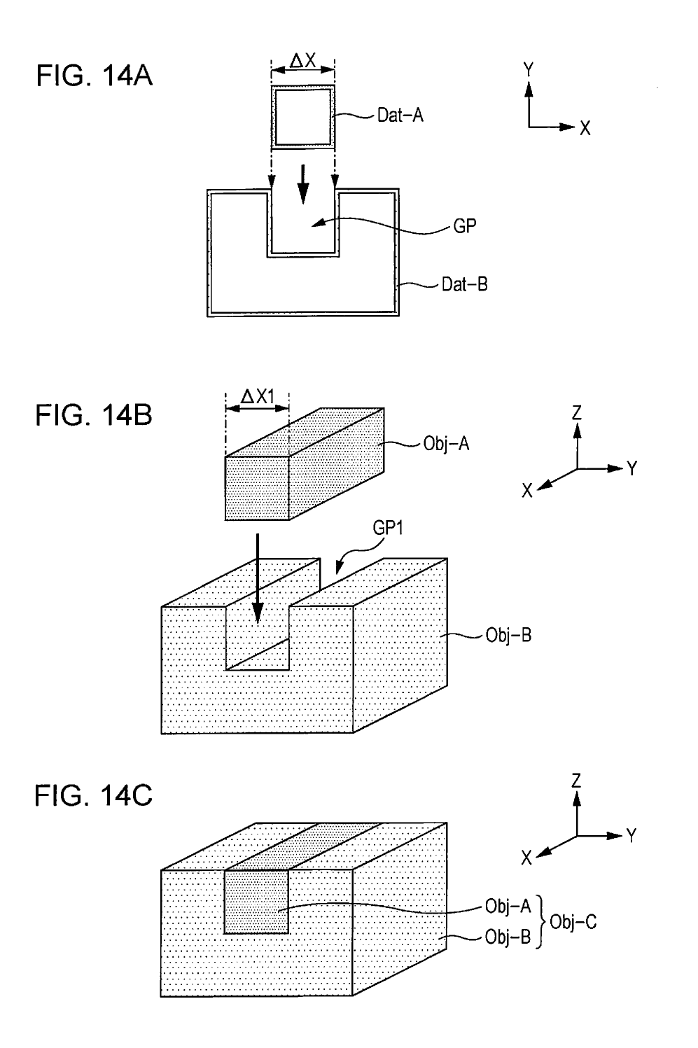

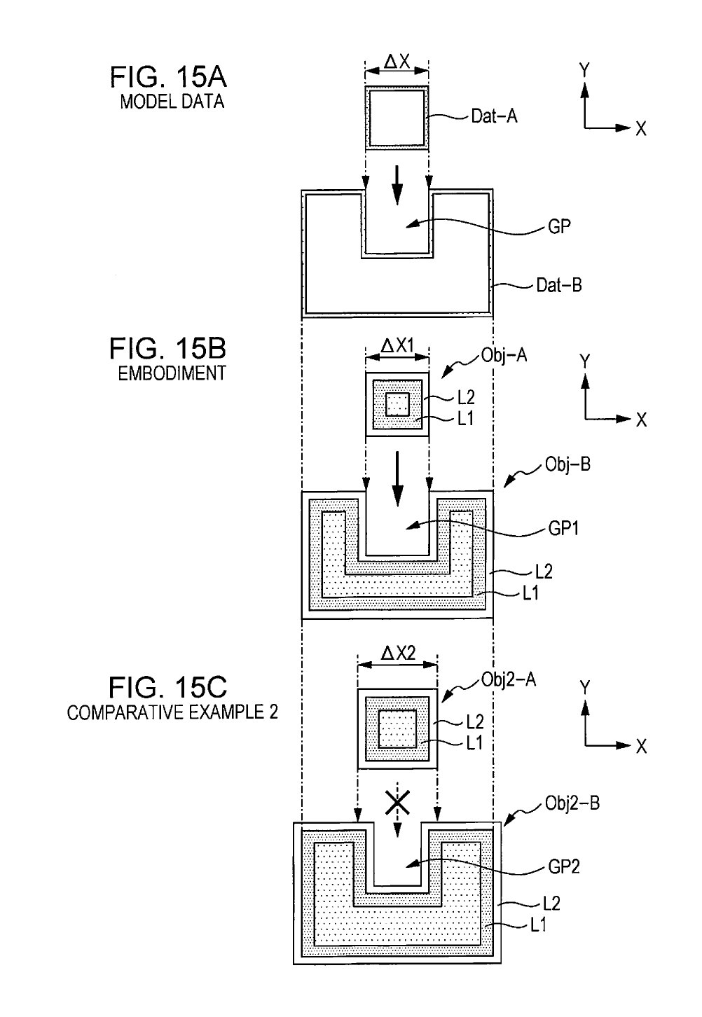

Herein, problems occurring when the three-dimensional object Obj2 having the larger size than that the size shown by the model data Dat is formed as in Comparative Example 2, will be described by comparing the three-dimensional object Obj according to the embodiment, with reference to FIGS. 14A to 15C.

FIGS. 14A to 14C are explanatory diagrams showing a three-dimensional object Obj-A formed based on model data Dat-A and a three-dimensional object Obj-B formed based on model data Dat-B by the three-dimensional object formation system 100 according to the embodiment. Among these, FIG. 14A is a sectional view showing a cutting surface when the model of the three-dimensional object Obj-A shown by the model data Dat-A is sectioned along a XY plane and a cutting surface when the model of the three-dimensional object Obj-B shown by the model data Dat-B is sectioned along a XY plane. FIGS. 14B and 14C are perspective views showing the three-dimensional objects Obj-A and Obj-B.

In the examples shown in FIGS. 14A to 15C, a case where a width ΔX of the model of the three-dimensional object Obj-A shown by the model data Dat in the X axis direction (see FIG. 14A) and a width ΔX1 of the three-dimensional object Obj-A formed by the three-dimensional object formation system 100 in the X axis direction (see FIG. 14B) are approximately the same, is assumed.

In the examples shown in FIGS. 14A to 15C, a case where the three-dimensional objects Obj-A and Obj-B are components of a three-dimensional object Obj-C is assumed. Specifically, a case where the three-dimensional object Obj-C is assembled by fitting the three-dimensional object Obj-A to a groove GP1 included in the three-dimensional object Obj-B.

More specifically, in this example, as shown in FIG. 14A, the model of the three-dimensional object Obj-B shown by the model data Dat-B includes a groove GP having a width (for example, width greater than by 0.1 mm to 1.0 mm) which is slightly greater than ΔX in the X axis direction. As shown in FIG. 14B, the three-dimensional object formation apparatus 1 forms the three-dimensional object Obj-B including a groove GP1 having approximately the same shape as that of the groove GP. Accordingly, as shown in FIG. 14C, the three-dimensional object Obj-C can be assembled by fitting the three-dimensional objects Obj-A and Obj-B to each other.

FIGS. 15A to 15C are explanatory diagrams for illustrating the three-dimensional objects Obj-A and Obj-B formed by the three-dimensional object formation system 100 according to the embodiment and three-dimensional objects Obj2-A and Obj2-B formed by the three-dimensional object formation system according to Comparative Example 2. For convenience, the drawings show cutting surfaces when the model data and the three-dimensional object are sectioned along a XY plane parallel to the X axis and the Y axis.

Among FIGS. 15A to 15C, FIG. 15A is a sectional view showing sectional views of the three-dimensional objects Obj-A and Obj-B shown by the model data items Dat-A and Dat-B in the same manner as in FIG. 14A, FIG. 15B is a sectional view showing sectional views of the three-dimensional objects Obj-A and Obj-B formed by the three-dimensional object formation system 100 according to the embodiment in the same manner as in FIG. 14B, and FIG. 15C is a sectional view showing sectional views of the three-dimensional objects Obj2-A and Obj2-B formed by the three-dimensional object formation system according to Comparative Example 2.

As shown in FIG. 15B, as described above, the three-dimensional object formation system 100 according to the embodiment forms the three-dimensional objects Obj-A and Obj-B so that the width of the three-dimensional object Obj-A is ΔX1 in the X axis direction and the three-dimensional object Obj-A can be fitted to the groove GP1 of the three-dimensional object Obj-B. Accordingly, the three-dimensional object Obj-C can be assembled using the formed three-dimensional objects Obj-A and Obj-B.

Meanwhile, as described above, the size of the three-dimensional object Obj2 formed by the three-dimensional object formation system according to Comparative Example 2 is greater than the size of the model shown by the model data Dat by the thickness of ΔL2 of the transparent layer L2. Specifically, as shown in FIG. 15C, the three-dimensional object Obj2-A formed by the three-dimensional object formation system according to Comparative Example 2 has the width ΔX2 in the X axis direction which is greater than the width ΔX shown by the model data Dat-A by “2×ΔL2”. The groove GP2 included in the three-dimensional object Obj2-B formed by the three-dimensional object formation system according to Comparative Example 2 is smaller than the width of the groove GP shown by the model data Dat-B in the X axis direction by “2×ΔL2”. Accordingly, it is difficult to fit the three-dimensional object Obj2-A to the groove GP2 included in the three-dimensional object Obj2-B. That is, it is difficult to assemble the three-dimensional object Obj-C using the three-dimensional objects Obj2-A and Obj2-B.

As described above, since the three-dimensional object formation system 100 according to the embodiment provides the transparent layer L2 so as to cover the chromatic layer L1, in the same manner as in three-dimensional object formation system according to Comparative Example 2, it is possible to protect the chromatic layer L1 with the transparent layer L2.

Meanwhile, in the three-dimensional object formation system according to Comparative Example 2, since the size of the formed three-dimensional object is greater than the size of the model shown by the model data Dat, this is not suitable in a case of forming the components shown in FIGS. 14A to 15C.

With respect to this, the three-dimensional object formation system 100 according to the embodiment forms the three-dimensional object Obj so that the size of the three-dimensional object Obj and the size of the model shown by the model data Dat are approximately the same. Therefore, the three-dimensional object formation system 100 according to the embodiment can form the three-dimensional object Obj which can be used for various purposes, such as components.

### 3. Conclusion of Embodiment

As described above, the three-dimensional object formation system 100 according to the embodiment forms the three-dimensional object Obj including the transparent layer L2 which is provided so as to cover the chromatic layer L1. Accordingly, it is possible to decrease a degree of deterioration over time regarding image quality relating to the pattern, characters, and other images represented with the color applied to the chromatic layer L1 of the three-dimensional object Obj.

Since the three-dimensional object formation system 100 according to the embodiment forms the three-dimensional object Obj having approximately the same size as that of the model shown by the model data Dat, it is possible to form the three-dimensional object Obj which can be used for various purposes, such as components.

In the embodiment, the chromatic ink is an example of “first liquid”, the clear ink is an example of “second liquid”, the white ink is an example of “third liquid”, the chromatic layer L1 is an example of a “first layer”, the transparent layer L2 is an example of a “second layer”, and the white layer L3 is an example of a “third layer”.

### B. MODIFICATION EXAMPLES

The above embodiment can be modified in various manners. Specific modified embodiments will be described hereinafter. Two or more embodiments arbitrarily selected from the below examples can be suitably combined with each other in a range not contradicting each other.

In the modification examples below, the same reference numerals used in the above description will be used for the elements exhibiting the same operations or functions as those in the above embodiment and the specific description thereof will be suitably omitted.

### Modification Example 1

In the embodiment described above, the chromatic layer L1 has the uniform thickness ΔL1 and the white layer L3 has the uniform thickness ΔL3, but the invention is not limited to this embodiment, and the thickness of the chromatic layer L1 and the thickness of the white layer L3 may not be uniform. That is, in the three-dimensional object Obj formed by the three-dimensional object formation system 100, at least the thickness of the transparent layer L2 may be uniform.

### Modification Example 2

In the embodiment and the modification examples described above, the three-dimensional object Obj formed by the three-dimensional object formation system 100 includes the transparent layer L2, the chromatic layer L1, the white layer L3, and the hollow portion HL from the outer surface SF to the inside of the three-dimensional object Obj, but the invention is not limited to this embodiment, and the three-dimensional object formation system 100 may form the three-dimensional object Obj including at least the chromatic layer L1 and the transparent layer L2 which is provided on the outer surface SF side with respect to the chromatic layer L1. That is, in the three-dimensional object Obj formed by the three-dimensional object formation system 100, any structure may be used for the structure for the inside with respect to the chromatic layer L1.

For example, the three-dimensional object Obj formed by the three-dimensional object formation system 100 may have a configuration of including a layer which is formed with the clear ink, instead of the white layer L3.

For example, the three-dimensional object Obj formed by the three-dimensional object formation system 100 may have a solid structure in which the entire of the inner side with respect to the chromatic layer L1 is filled with at least one of a layer formed with the white ink and a layer formed with the clear ink, without providing the hollow portion HL.

For example, the three-dimensional object Obj formed by the three-dimensional object formation system 100 may have a configuration of providing a layer formed with ink which is a curable ink other than the white ink and ink which can reflect visible light at a rate equal to or greater than a predetermined rate, instead of the white layer L3. For example, a layer formed with light cyan ink, light magenta ink, or achromatic light ink may be provided, instead of the white layer L3.

### Modification Example 3

In the embodiment and the modification examples described above, the three-dimensional object formation apparatus 1 forms the three-dimensional object Obj by laminating the formation bodies LY which are formed by curing the formation ink, but the invention is not limited to the embodiment, and formation bodies LY may be formed by solidifying powder spread in a layered shape by curable formation ink and the three-dimensional object Obj may be formed by laminating the formed formation bodies LY.

In this case, the three-dimensional object formation apparatus 1 may include a powder layer formation unit (not shown) which spreads the powder on the formation table 45 to have the predetermined thickness ΔZ to form a powder layer PW and a powder discarding unit (not shown) which discards the powder (powder other than powder solidified by the formation ink) not configuring the three-dimensional object Obj after forming the three-dimensional object Obj. Hereinafter, the powder layer PW for forming the formation body LY[q] is referred to as the powder layer PW[q].

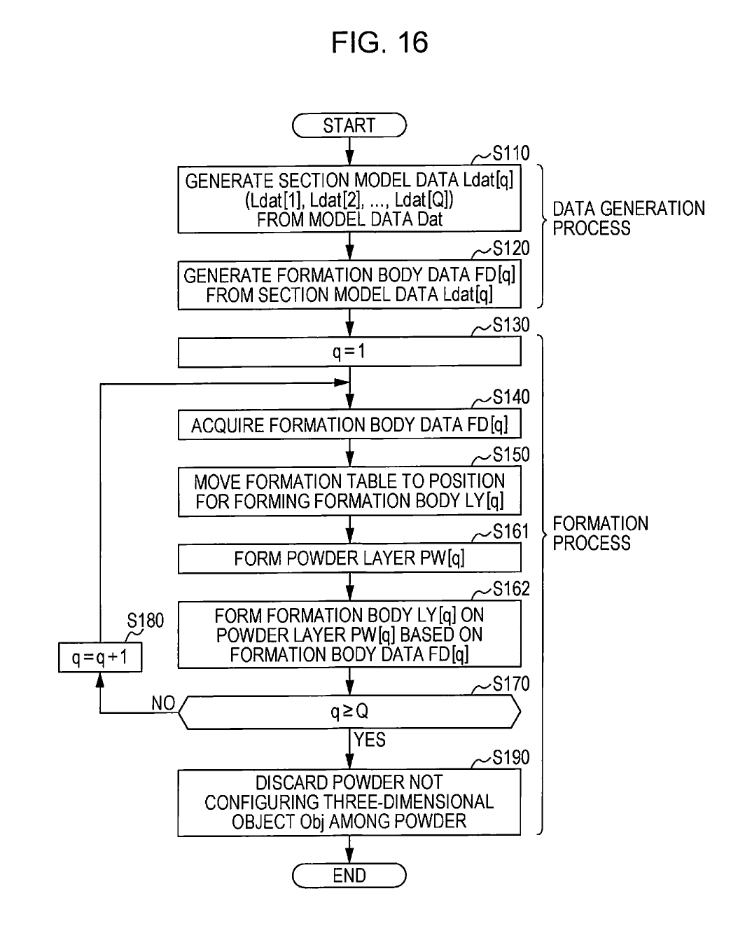

FIG. 16 is a flowchart showing an example of the operation of the three-dimensional object formation system 100 when executing the data generation process and the formation process according to the modification example. The flowchart according to the modification example shown in FIG. 16 is the same as the flowchart according to the embodiment shown in FIG. 10, except for executing the process shown in Steps S161 and S162 instead of Step S160 and executing the process shown in Step S190 when the determined result in Step S170 is positive.

As shown in FIG. 16, the control unit 6 according to the modification example controls the operation of each unit of the three-dimensional object formation apparatus 1 so that the powder layer formation unit forms the powder layer PW[q] (S161).

The control unit 6 according to the modification example controls the operation of each unit of the three-dimensional object formation apparatus 1 so as to form dots on the powder layer PW[q] to form the formation body LY[q] based on the formation body data FD[q] (S162). Specifically, first, in Step S162, the control unit 6 controls the operation of the head unit 3 so that the formation ink or the supporting ink are discharged to the powder layer PW[q] based on the formation body data FD[q]. Next, the control unit 6 controls the operation of the curing unit 61 so as to solidify the powder of a portion where the dots are formed on the powder layer PW[q], by curing the dots formed with the ink discharged to the powder layer PW[q]. Accordingly, the powder of the powder layer PW[q] is solidified with the ink and the formation body LY[q] can be formed.

The control unit 6 according to the modification example controls the operation of the powder discarding unit so as to discard the powder not configuring the three-dimensional object Obj after the three-dimensional object Obj is formed (S190).

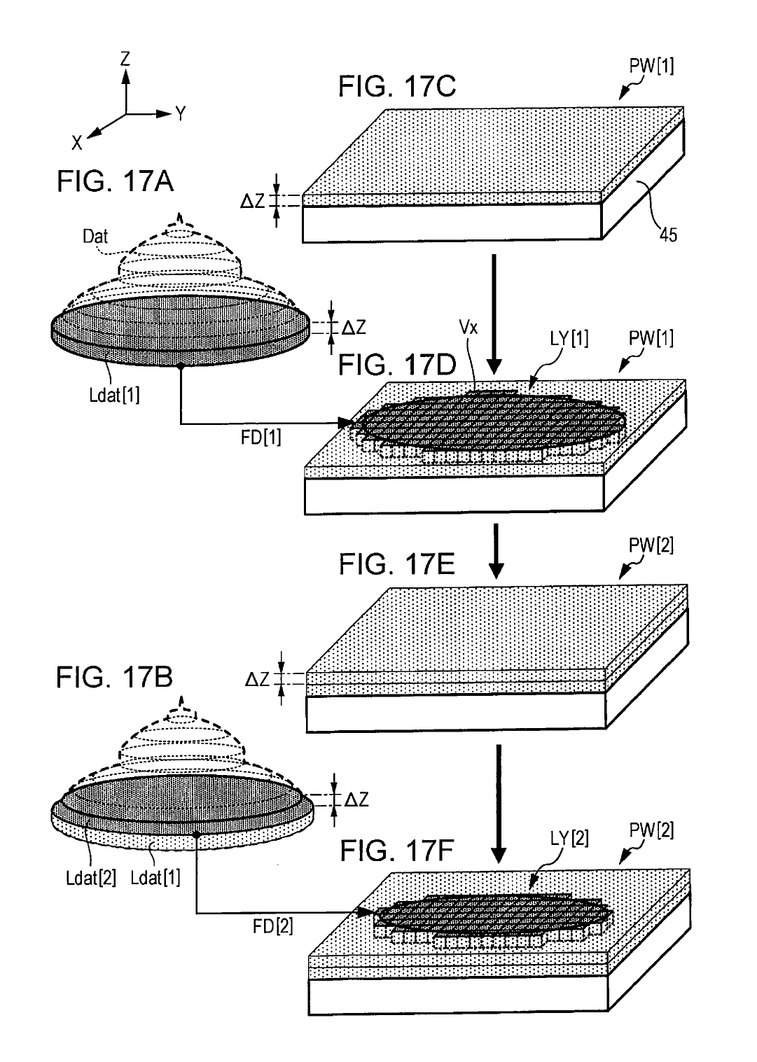

FIGS. 17A to 17F are explanatory diagrams for illustrating a relationship between the model data Dat and the section model data Ldat[q], the formation body data FD[q], the powder layer PW[q], and the formation body LY[q].

Among these, FIGS. 17A and 17B show the section model data items Ldat[1] and Ldat[2] in the same manner as in FIGS. 2A and 2B. Even in the modification example, the section model data Ldat[q] is generated by slicing the model data Dat, the formation body data FD[q] is generated from the section model data Ldat[q], and the formation body LY[q] is formed with the dots formed based on the formation body data FD[q]. Hereinafter, the formation of the formation body LY[q] according to the modification example will be described with reference to FIGS. 17C to 17F using the formation bodies LY[1] and LY[2] as examples.

As shown in FIG. 17C, the control unit 6 controls the operation of the powder layer formation unit so as to form the powder layer PW[1] having the predetermined thickness ΔZ before forming the formation body LY[1] (see Step S161 described above).

Next, as shown in FIG. 17D, the control unit 6 controls the operation of each unit of the three-dimensional object formation apparatus 1 so that the formation body LY[1] is formed in the powder layer PW[1] (see Step S162 described above). Specifically, first, the control unit 6 controls the operation of the head unit 3 based on the formation body data FD[1] to discharge the ink to the powder layer PW[1] to form the dots. Then, the control unit 6 controls the curing unit 61 so as to cure the dots formed on the powder layer PW[1] to solidify the powder in a portion where the dot is formed and form the formation body LY[1].

After that, as shown in FIG. 17E, the control unit 6 controls the powder layer formation unit so as to form the powder layer PW[2] having the predetermined thickness ΔZ on the powder layer PW[1] and the formation body LY[1]. As shown in FIG. 17F, the control unit 6 controls the operation of each unit of the three-dimensional object formation apparatus 1 so that the formation body LY[2] is formed.

As described above, the control unit 6 forms the formation body LY[q] in the powder layer PW[q] based on the formation body data FD[q] and laminates the formation bodies LY[q] to form the three-dimensional object Obj.

### Modification Example 4

In the embodiment described above, the ink discharged from the discharging unit D is curable ink such as an ultraviolet curable ink, but the invention is not limited to the embodiment, and ink formed of a thermoplastic resin may be used.

In this case, it is preferable that the ink is discharged in a state of being heated in the discharging unit D. That is, the discharging unit D according to the modification example preferably performs a so-called thermal type discharging process of generating air bubbles in the cavity 320 to increase pressure in the cavity 320 by heating a heating element (not shown) provided in the cavity 320, to discharge the ink.

In this case, since the ink discharged from the discharging unit D is cooled and cured by the outside air, the three-dimensional object formation apparatus 1 may not include the curing unit 61.

### Modification Example 5

In the embodiment and the modification examples described above, the sizes of the dots which can be discharged by the three-dimensional object formation apparatus 1 are three of a small dot, a medium dot, and a large dot, but the invention is not limited to this embodiment, and the sizes of the dots which can be discharged by the three-dimensional object formation apparatus 1 may be one or more.

### Modification Example 6

In the embodiment and the modification examples described above, the formation data generation unit 93 is provided in the host computer 9, but the invention is not limited to this embodiment, and the formation data generation unit 93 may be provided in the three-dimensional object formation apparatus 1. For example, the formation data generation unit 93 may be mounted as a functional block which is realized by operation of the control unit 6 according to the control program.

When the three-dimensional object formation apparatus 1 includes the formation data generation unit 93, the three-dimensional object formation apparatus 1 can generate the formation body data FD based on the model data Dat supplied from the outside and form the three-dimensional object Obj based on the generated formation body data FD.

### Modification Example 7

In the embodiment and the modification examples described above, the three-dimensional object formation system 100 includes the model data generation unit 92, but the invention is not limited to this embodiment, and the three-dimensional object formation system 100 may be configured without including the model data generation unit 92.

That is, the three-dimensional object formation system 100 may form the three-dimensional object Obj based on the model data Dat supplied from the outside of the three-dimensional object formation system 100.

### Modification Example 8

In the embodiment and the modification examples described above, the driving waveform signal Com is a signal including the waveforms PL1 to PL3, but the invention is not limited to this embodiment, and the driving waveform signal Com may be any signal, as long as it is a signal including a waveform at which the amounts of ink corresponding to at least one type of the size of the dot can be discharged from the discharging unit D. For example, the driving waveform signal Com may be set as a different waveform depending on the type of the ink.

In addition, in the embodiment and the modification examples described above, the bit number of the waveform designation signal SI[m] is two bits, but the invention is not limited to this embodiment, and the bit number of the waveform designation signal SI[m] may be suitably determined depending on the number of types of the sizes of the dots formed with the ink discharged from the discharging unit D.

What is claimed is:

1. A three-dimensional object formation apparatus comprising:
a head unit which discharges a plurality of types of liquid including first liquid including chromatic color material components and second liquid having a smaller number of color material components than that of the first liquid and forms dots with the discharged liquid;
a curing unit which cures the dots; and
a formation control unit which controls the head unit so that a three-dimensional object is formed with the cured dots,
wherein the formation control unit controls the head unit so that the three-dimensional object which includes a first layer formed of a plurality of dots including the dots formed with the first liquid and a second layer formed of a plurality of dots formed with the second liquid and in which the second layer includes an outer surface of the three-dimensional object and is provided so as to separate the first layer and the outer surface of the three-dimensional object, is formed.

2. The three-dimensional object formation apparatus according to claim 1,
wherein the formation control unit controls the head unit so that the three-dimensional object in which the first layer shows the color shown by model data and is provided to be separated from the outer surface of the three-dimensional object determined based on the shape shown by the model data by a distance corresponding to a thickness of the second layer, is formed based on the model data for designating the shape and the color of the three-dimensional object.

3. The three-dimensional object formation apparatus according to claim 2,
wherein the three-dimensional object is formed by sequentially overlapping a plurality of formation bodies,
a formation body which is initially formed and a formation body which is finally formed are formed with the second liquid,
the formation bodies are formed with the cured dots, and
the formation control unit controls the head unit so that the formation bodies are formed based on the model data.

4. The three-dimensional object formation apparatus according to claim 1,
wherein the head unit discharges third liquid which reflects visible light at a rate equal to or greater than a predetermined rate, and
the formation control unit controls the head unit so that a three-dimensional object which is a three-dimensional object including a third layer formed of a plurality of dots formed with the third liquid and in which the first layer is provided so as to separate the third layer and the second layer, is formed.

5. The three-dimensional object formation apparatus according to claim 1,
wherein the formation control unit controls the head unit so that the three-dimensional object which is provided so as to have a constant thickness of the second layer is formed.

6. A three-dimensional object formation system which forms a three-dimensional object based on model data for designating a shape and a color of the three-dimensional object to be formed, the system comprising:
a head unit which discharges a plurality of types of liquid including first liquid including chromatic color material components and second liquid having a smaller number of color material components than that of the first liquid and forms dots with the discharged liquid;
a curing unit which cures the dots; and
a system control unit which controls the head unit so that the three-dimensional object is formed with the cured dots based on the model data,
wherein the system control unit controls the head unit so that the three-dimensional object which includes a first layer which is formed of a plurality of dots including the dots formed with the first liquid and for representing the color shown by the model data, and a second layer formed of a plurality of dots formed with the second liquid, includes outer surface of the three-dimensional object determined based on the shape shown by the model data, and is provided so as to separate the first layer and the outer surface of the three-dimensional object, and in which the first layer is provided so as to be separated from the outer surface of the three-dimensional object by a distance corresponding to a thickness of the second layer, is formed.

7. A control method of a three-dimensional object formation apparatus which includes a head unit which discharges a plurality of types of liquid including first liquid including chromatic color material components and second liquid having a smaller number of color material components than that of the first liquid and forms dots with the discharged liquid, and a curing unit which cures the dots, the method comprising:
controlling the head unit so that the three-dimensional object which includes a first layer formed of a plurality of dots including the dots formed with the first liquid and a second layer formed of a plurality of dots including the dots formed with the second liquid and in which the second layer includes an outer surface of the three-dimensional object and is provided so as to separate the first layer and the outer surface of the three-dimensional object, is formed.

8. A control program of a three-dimensional object formation apparatus which includes a head unit which discharges a plurality of types of liquid including first liquid including chromatic color material components and second liquid having a smaller number of color material components than that of the first liquid and forms dots with the discharged liquid, a curing unit which cures the dots, and a computer, the program causing the computer to function as:
a formation control unit which controls the head unit so that the three-dimensional object which includes a first layer formed of a plurality of dots including the dots formed with the first liquid and a second layer formed of a plurality of dots formed with the second liquid and in which the second layer includes an outer surface of the three-dimensional object and is provided so as to separate the first layer and the outer surface of the three-dimensional object, is formed with the cured dots.
